(19) United States
(12) Patent Application Publication
(10) Pub. No.: US 2024/0361022 A1
(43) Pub. Date: Oct. 31, 2024

(54) HUMIDIFIER

(71) Applicant: LG ELECTRONICS INC., Seoul (KR)

(72) Inventors: Keunman PARK, Seoul (KR); Hyunpll Ha, Seoul (KR); Sangheon Lee, Seoul (KR); Kunyoung Lee, Seoul (KR)

(21) Appl. No.: 18/644,645

(22) Filed: Apr. 24, 2024

(30) Foreign Application Priority Data
Apr. 27, 2023 (KR) 10-2023-0055151

(51) Int. Cl. F24F 6/12; C02F 1/42; F24F 6/00; F24F 13/20; F24F 140/00

(52) U.S. Cl. CPC F24F 6/12; C02F 1/42; F24F 13/20; F24F 2006/006; F24F 2006/008; F24F 2140/00

(57) ABSTRACT

A humidifier may include a tank that stores water; a first humidifying water tank that is disposed at a lower side of the water tank and heats water supplied from the water tank using a heater; a second humidifying water tank that is disposed at the lower side of the water tank and generates humidified air using water supplied from the first humidifying water tank via a vibrator; a first connection pipe that connects the first humidifying water tank and the second humidifying water tank; a first valve that opens and closes a flow path connecting the water tank and the first humidifying water tank; a second valve that opens and closes the first connection pipe; and a first temperature sensor that detects a temperature of water inside of the first humidifying water tank. The second valve may open the first connection pipe, when the temperature of water detected by the first temperature sensor is equal to or higher than a first predetermined temperature.

### CROSS-REFERENCE TO RELATED APPLICATION(S)

This application claims priority under 35 U.S.C. § 119 to Korean Application No. 10-2023-0055151, filed in Korea on Apr. 27, 2023, whose entire disclosure is hereby incorporated by reference.

### BACKGROUND

### 1. Field

A humidifier is disclosed herein.

### 2. Background

A humidifier is an apparatus that evaporates water and emits humidified air with a high moisture content. A humidifier can create humidified air by evaporating water through natural evaporation, heated evaporation, or ultrasonic vibration.

Each evaporation method has its advantages and disadvantages. In the case of natural evaporation, there is a problem that a user must frequently manage the humidifying medium used.

In the case of evaporation by ultrasonic vibration, there are problems in that the humidified air may not flow actively into the indoor space by atomizing the supplied water with ultrasonic vibration, in that unpleasant humidified air may flow into the indoor space when unsterilized water is humidified, and in that an ultrasonic vibrator is vulnerable to high temperature heat. In the case of heating evaporation, safety accidents may occur if hot humidified air is discharged directly.

Korean registered patent No. KR 10-0158806, which is hereby incorporated by reference, discloses a humidifier that humidifies water supplied from a water tank by heating and ultrasonic vibration. However, the prior art document discloses a structure in which a water heating space and a humidifying space are connected to each other. This causes a problem in that the water cannot be completely sterilized when a water heating temperature is maintained below a set or predetermined temperature in consideration of an ultrasonic vibrator. In addition, when water is heated for sterilization and sent to the ultrasonic vibrator, there is a problem that the ultrasonic vibrator may malfunction. That is, in the case of the prior art document, there is difficulty in completely sterilizing and humidifying water.

In addition, if a heater for heating and a vibrator for humidification are disposed in the same space, a problem that water that is not completely heated may be humidified may occur.

### BRIEF DESCRIPTION OF THE DRAWINGS

Embodiments will be described in detail with reference to the following drawings in which like reference numerals refer to like elements, and wherein:

FIG. 1 is a perspective view of a humidifier according to an embodiment;

FIG. 2 is a plan view of the humidifier of FIG. 1;

FIG. 3 is a cross-sectional view, taken along line III-III′ of FIG. 2;

FIG. 4 is an exploded perspective view of a water tank cover, an inner water tank, an outer water tank, an inner shell, and an outer shell according to an embodiment;

FIG. 5 is a cross-sectional view of an inner water tank according to an embodiment;

FIG. 6 is an exploded perspective view of a water tank, an inner shell, and a middle tray according to an embodiment;

FIG. 7 is a perspective view of a middle tray according to an embodiment;

FIG. 8 is a cross-sectional perspective view of a water tank, an inner shell, and a middle tray which are coupled according to an embodiment;

FIG. 9 is a perspective view of a state in which a humidifying module and a middle tray are coupled according to an embodiment;

FIG. 10 is a cross-sectional view cut off on one side of the humidifying module and the middle tray of FIG. 9;

FIG. 11 is a side view of a first humidifying water tank and a second humidifying water tank which are coupled according to an embodiment;

FIG. 12 is a side view viewed from another direction of the first humidifying water tank and the second humidifying water tank which are coupled according to an embodiment;

FIG. 13 is a cross-sectional view in one direction of a first humidifying water tank and a second humidifying water tank which are coupled according to another embodiment;

FIG. 14 is a cross-sectional view from a different direction of the first humidifying water tank and the second humidifying water tank of FIG. 13;

FIG. 15 is a perspective view for explaining upper surfaces of a first humidifying water tank and a second humidifying water tank according to another embodiment;

FIG. 16 is a cross-sectional view of one side for explaining an arrangement of a second supply hole in the first humidifying water tank according to an embodiment;

FIG. 17 is a schematic diagram for explaining a specific connection relationship and internal configuration arrangement of a first humidifying water tank and a second humidifying water tank according to an embodiment;

FIG. 18 is a schematic diagram for explaining an internal configuration of a first humidifying water tank and structure connected thereto according to an embodiment;

FIG. 19 is a perspective view of a state in which a humidifying module and a middle tray are coupled according to another embodiment;

FIG. 20 is a cross-sectional view cut off on one side of the humidifying module and the middle tray of FIG. 19;

FIG. 21 is a cross-sectional view with a flow path case added to FIG. 20;

FIG. 22 is a perspective view of a humidifying module housing according to another embodiment; and

FIG. 23 is a schematic diagram for explaining a specific connection relationship and internal configuration arrangement of a first humidifying water tank and a second humidifying water tank according to the embodiment of FIG. 23.

### DETAILED DESCRIPTION

Advantages and features of embodiments and methods of achieving them will become apparent with reference to the embodiments described below in conjunction with the accompanying drawings. However, the embodiments are not limited to the embodiments disclosed below, but may be implemented in various different forms, and these embodiments are provided only to allow the disclosure to be complete, and to completely inform those of ordinary skill in the art to which embodiments belong, the scope, and the embodiments are only defined by the scope of the claims. Like reference numerals refer to like elements throughout.

Hereinafter, embodiments will be described with reference to the drawings.

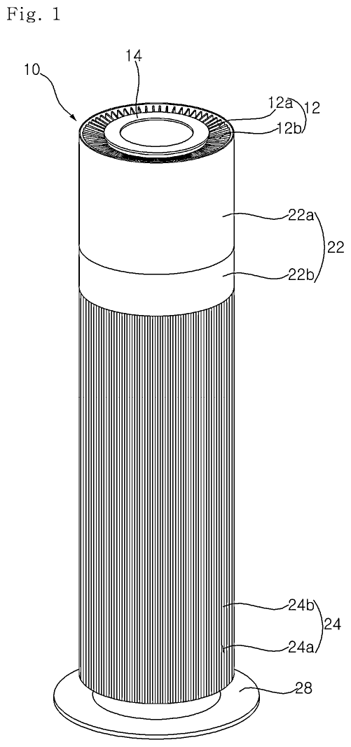

First, an overall configuration of a humidifier according to an embodiment will be described with reference to FIGS. 1 to 3.

A humidifier according to embodiments may humidify water using ultrasonic vibration. The humidifier according to embodiments may discharge humidified air by heating water. The humidifier according to embodiments may discharge humidified air generated by ultrasonic vibration and humidified air generated by heating.

Referring to FIGS. 1 to 3, the humidifier may include a case 10 that forms an outer shape and has an inlet 24a and an outlet 12a, a filter device that is disposed inside of the case 10 and filters the air flowing into the inlet 24a, a blower 60 that is disposed inside of the case 10 and blows the air inside of the case 10 from the inlet 24a to the outlet 12a, and a humidifying module that is disposed inside of the case 10 and humidifies a portion of the air flowing to the blower 60.

The humidifying module may include a first humidifying water tank 300 that heats water and a second humidifying water tank 350 that generates humidified air using water. The humidifying module may include a humidifying module housing 410 that covers a circumference of the first humidifying water tank 300 and the second humidifying water tank 350. A flow path housing 430 may be disposed at an outer circumference of the humidifying module housing 410. A blower flow path 70 may be formed between the humidifying module housing 410 and the flow path housing 430. A configuration and arrangement of the humidifying module will be described hereinafter.

The case 10 may have an overall cylindrical shape. The case 10 may include a suction grill 24 that forms the inlet 24a through which air flows in, and a discharge grill 12 that forms the outlet 12a through which air is discharged.

The inlet 24a may be formed on a circumferential surface of the case 10 having a cylindrical shape. The outlet 12a may be formed on an upper surface of the case 10 having a cylindrical shape. The humidifier may draw in air into the circumferential surface and discharge air through the upper surface.

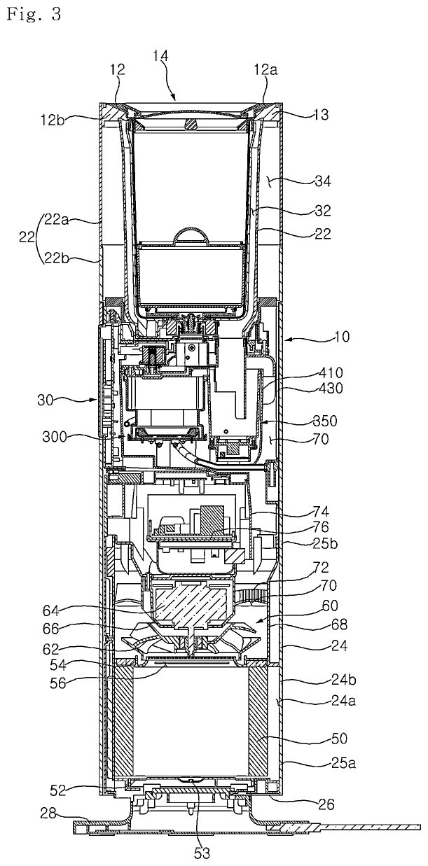

Referring to FIG. 3, the suction grill 24 may cover an outside of a filter 50 and a blower housing 68, which will be described hereinafter. A plurality of inlets 24a may be formed in the suction grill 24 in a vertical direction and spaced apart in a circumferential direction. The inlet 24a may be formed around where the filter 50 is disposed. The inlet 24a may be formed in a lower portion of the suction grill 24. An upper portion of the suction grill 24 may be closed to protect internal component of the humidifier.

A plurality of grills 24b that extends in an upward-downward direction may be disposed in the suction grill 24. The plurality of grills 24b may be spaced apart in the circumferential direction of the suction grill 24. A plurality of inlets 24a may be formed between the plurality of grills 24b.

The suction grill 24 may be divided into a suction grill lower portion 25a in which the inlet 24a is formed, and a suction grill upper portion 25b disposed in or at an upper side of the suction grill lower portion 25a. A display 30, which will be described hereinafter, may be disposed in the suction grill upper portion 25b. The suction grill upper portion 25b may cover the blower housing 68 and an outside of the humidifying module described hereinafter.

The humidifier may include the discharge grill 12 forming the outlet 12a and a water tank cover 14 disposed at an upper side of the water tank 100. The discharge grill 12 may be separated upward from an outer shell 22 described hereinafter. The water tank cover 14 may be separated from the discharge grill 12 or a water tank 100. The discharge grill 12 may include a plurality of ribs 12b that extends in a radial direction from an outer circumference of the water tank cover 14. The plurality of ribs 12b disposed in the discharge grill 12 may be spaced apart in the circumferential direction in the outer circumference of the water tank cover 14.

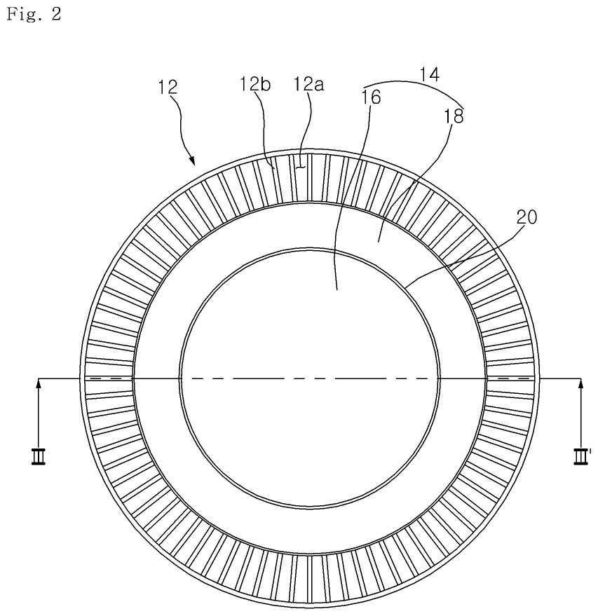

Referring to FIG. 2, the water tank cover 14 may include a central cover 16 and a peripheral cover 18 disposed around the central cover 16. The central cover 16 may have a structure that is convex upward as it extends toward a center thereof. A water supply hole 20 through which water may be received into the water tank 100 may be formed between the peripheral cover 18 and the central cover 16.

Referring to FIG. 1, the discharge grill 12 may be disposed above a first discharge flow path 32 and a second discharge flow path 34, which will be described hereinafter. A plurality of ribs 12b and a plurality of outlets 12a may be formed in the discharge grill 12.

The discharge grill 12 may have a constant height in the upward-downward direction. Accordingly, a mixing passage 13 may be formed between the plurality of ribs 12b disposed in the discharge grill 12. In the mixing passage 13, the air flowing through the first discharge flow path 32 and the air flowing through the second discharge flow path 34 may be mixed.

For each of the plurality of ribs 12b, a height of an outer circumferential end may be formed to be higher than a height of an inner peripheral end. Accordingly, the air flowing through the first discharge flow path 32 and the second discharge flow path 34 may be guided inward in the radial direction.

The case 10 may include the outer shell 22 that guides air flowing inside to the outlet 12a. The outer shell 22 may include an inner shell 180 and the second discharge flow path 34, which will be described hereinafter.

The outer shell 22 may include an upper outer shell 22a disposed below the discharge grill 12, and a lower outer shell 22b disposed below the upper outer shell 22a. The lower outer shell 22b may be formed of a transparent material, for example.

The case 10 may include a lower wall 26 that covers a lower side of the suction grill 24. The humidifier may include a pedestal 28 that is disposed on or at a lower side of the case 10 and spaced apart from the lower wall 26 by a predetermined distance from the ground. An upper end of the pedestal 28 may be connected to the lower wall 26. The lower wall 26 may cover a lower surface of the humidifier spaced upward from the ground by the pedestal 28.

Referring to FIG. 2, a display 30 may be disposed in or at one side of the case 10. The display 30 allows a user to control a power or operation of the humidifier. A display that displays an operating state of the humidifier to a user may be disposed in the display 30.

The filter device may filter the air introduced through the inlet 24a via the filter 50. The filter device may direct the filtered air upward.

Referring to FIG. 3, the filter device may include the filter 50 that filters the air flowing into the inlet 24a, and a filter mounter that fixes a position of the filter 50 inside of the case 10. The filter 50 may have a cylindrical shape, for example. Accordingly, the filter 50 may filter the air suctioned from front, rear, left, and right directions perpendicular to the upward-downward direction. The air introduced from the inlet 24a may flow into an inner space of the filter 50. The air passed through the filter 50 may flow to the blower 60 disposed at an upper side of the filter 50.

The filter mounter may include a lower plate 52 disposed at a lower side of the filter 50, an upper plate 54 disposed at the upper side of the filter 50, and a supporter that connects the lower plate 52 and the upper plate 54.

The lower plate 52 may be disposed at the lower side of the filter 50. The lower plate 52 may move up and down, and may detect whether the filter 50 is disposed thereon. A fan sterilizing device 53 that irradiates ultraviolet light upward may be disposed at a center of the lower plate 52. The fan sterilizing device 53 may sterilize an inside of a fan 62 described hereinafter or the filter 50.

An orifice 56 may be formed in the upper plate 54. The orifice 56 may be formed in a center of the upper plate 54. The orifice 56 may allow the air blown into the inner space of the filter 50 to flow to the fan 62.

An inner circumferential end of the upper plate 54 may have a shape bent upward, so that air flowing upward in the inner space of the filter 50 may be guided to the fan 62. The supporter may connect the lower plate 52 and the upper plate 54. The supporter may be spaced apart in the circumferential direction.

The blower 60 may include the fan 62 that generates airflow inside of the case 10, and a fan motor 64 that rotates the fan 62. Referring to FIG. 3, the fan 62 may form a fan suction port at one side toward the orifice 56, and may form a fan discharge port in a direction opposite to the fan suction port. The fan 62 may be a mixed flow fan a fan discharge outlet of which faces in a centrifugal direction in a direction opposite to the fan suction port. The fan 62 may include a hub connected to the fan motor 64, a shroud that is spaced apart from the hub by a predetermined distance and forms the fan suction port, and a blade that extends in a radial direction to connect the hub and the shroud.

The fan 62 may operate to blow air from the lower side thereof upward. The fan 62 suctions air into the orifice 56 and discharges the air to the blower housing 68 where the diffuser 72 is disposed. The fan motor 54 may be disposed above the fan 62.

The blower device may include a motor cover 66 that covers an outside of the fan motor 64, and a blower housing 68 that is spaced radially outward from the motor cover 66 and guides the air flowing by the fan 62 upward. The blower flow path 70 through which air blown by the fan 62 flows upward may be formed between the motor cover 66 and the blower housing 68. The blower flow path 70 may extend to an area where the humidifying module housing 410 and the flow path housing 430 are formed. The suction grill 24 may be disposed at an outside of the blower housing 68.

The blower 60 may include the diffuser 72 disposed between the motor cover 66 and the blower housing 68 and reduce a rotational component of air blown upward by the fan 62. A plurality of diffusers 72 may be spaced apart in the circumferential direction.

A control box 74 may be disposed at an upper side of the motor cover 66 to form a space in which a circuit board 76 may be disposed. The control box 74 may be spaced apart from an inside of the blower housing 68. Therefore, the blower flow path 70 may be formed in a space between the control box 74 and the blower housing 68. A plurality of circuit boards 76 may be disposed inside of the control box 74.

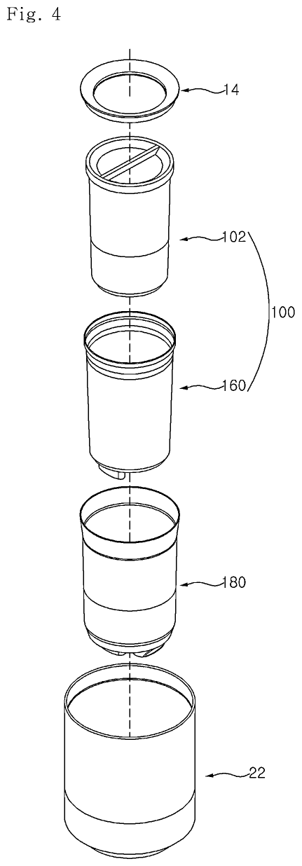

Hereinafter, with reference to FIGS. 4 to 8, a discharge flow path and a water tank that stores water will be described.

The humidifier may include the water tank 100 that forms a space that stores water, the inner shell 180 spaced apart from an outer circumference of the water tank 100, and the outer shell 22 spaced apart from an outer circumference of the inner shell 180. The humidifier may include the water tank cover 14 disposed at an upper side of the water tank 100.

The water tank 100 may include an inner water tank 102 that forms a space in which water is stored, and an outer water tank 160 disposed to cover an outside of the inner water tank 102. The inner water tank 102 may be disposed inside of the outer water tank 160. When the inner water tank 102 is disposed inside of the outer water tank 160, an outer circumferential surface of the inner water tank 102 may be disposed to be in contact with an inner circumferential surface of the outer water tank 160.

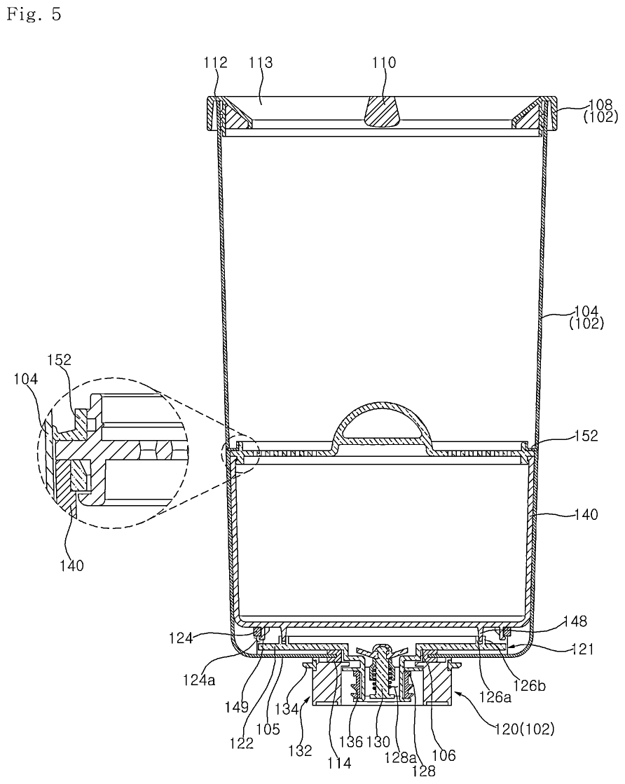

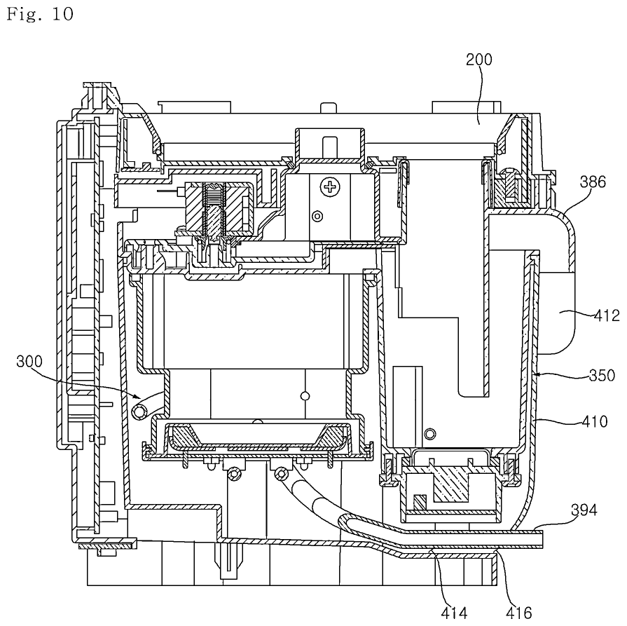

Referring to FIG. 5, the inner water tank 102 may include an inner water tank body 104 that forms a space in which water is stored, a handle 108 disposed at an upper side of the inner water tank body 104, and a connector 120 that is disposed at a lower side of the inner water tank body 104 and connects the inner water tank body 104 with a supply pipe 230 (see FIG. 10) described hereinafter.

Referring to FIG. 5, a water softener 140 may be disposed inside of the inner water tank 102 to harden the water inside of the inner water tank 102. The water softener 140 may include a water softener housing 142 that forms a space in which an ion exchange resin filter (not shown) is disposed, and a housing cover 150 that covers an upper side of the water softener housing 142. A plurality of cover holes 150b may be formed in the housing cover 150, and a plurality of housing holes (not shown) may be formed in the water softener housing 142.

The inner water tank body 104 may be formed in a substantially cylindrical shape, for example. The inner water tank body 104 may have a shape having an open upper side. A lower hole 106 through which water stored at a lower side is discharged may be formed in the inner water tank body 104. Referring to FIG. 5, the inner water tank body 104 may have a shape for which an inner diameter of the water tank decreases from the upper side to the lower side.

The lower hole 106 may be formed at a center of the lower surface of the inner water tank body 104. The connector 120 may be fixedly disposed in the lower hole 106. Water stored in the inner water tank 102 may flow to the supply pipe 230 through the connector 120 mounted in the lower hole 106.

The handle 108 may include a handle fixing portion 112 fixedly disposed in an upper end of the inner water tank body 104, and a handle bar 110 disposed across the upper side of the inner water tank body 104.

The handle fixing portion 112 may hang on the upper end of the inner water tank body 104. In the handle fixing portion 112, an area disposed inside of the inner water tank body 104 may include an inclined wall 113 inclined to inner and lower sides of the inner water tank body 104. Therefore, water falling through the water tank cover 14 may flow into the inner water tank 102 along the inclined surface of the handle fixing portion 112.

Referring to FIG. 5, the connector 120 may include a connector body 121 configured to penetrate the lower hole 106 of the inner water tank body 104, a connector holder 132 that is coupled to the connector body 121 and fixes an arrangement of the connector body 121, and a connector valve 130 that is disposed inside of the connector body 121 and opens and closes an internal flow path 128a of the connector body 121.

Referring to FIG. 5, the connector body 121 may include a connector plate 122 disposed inside of the inner water tank body 104, and a connector pipe 128 that penetrates the lower hole 106 of the inner water tank body 104 and forms the internal flow path 128a. The connector plate 122 may be disposed at an upper side of the lower surface of the inner water tank body 104.

The connector plate 122 may have a structure that fixes the arrangement of the water softener 140 by contacting a lower portion of the water softener 140. A fixing rib 126a, 126b that protrudes upward may be disposed in or on the connector plate 122.

Referring to FIG. 5, the fixing rib 126a, 126b may include first fixing rib 126a, and second fixing rib 126b radially spaced apart from the first fixing rib 126a. A lower protrusion 144 of the water softener 140 may be disposed in a space between the first fixing rib 126a and the second fixing rib 126b. The first fixing rib 126a and the second fixing rib 126b may prevent the water softener 140 disposed inside of the inner water tank 102 from moving in a direction perpendicular to the upward-downward direction.

A border wall 124, which is disposed radially outward from the fixing rib 126a, 126b and protrudes upward, may be disposed in or on the connector plate 122. Referring to FIG. 5, a hook hole 124a into which a hook 145 of the water softener 140 is inserted may be formed in the border wall 124.

The connector pipe 128 may extend downward from a center of the connector plate 122. The connector pipe 128 may penetrate the lower hole 106 of the inner water tank body 104. The internal flow path 128a through which the water inside of the inner water tank 102 flows may be formed inside of the connector pipe 128. The connector valve 130 that opens and closes the internal flow path 128a may be disposed inside of the connector pipe 128.

The connector valve 130 may be configured to move in the upward-downward direction inside of the connector pipe 128. When connected to the supply pipe 230 described hereinafter, the connector valve 130 may move upward to open the internal flow path 128a.

The connector holder 132 may be fixedly disposed at an outer circumference of the connector pipe 128. The connector holder 132 may be disposed at the lower side of the lower surface of the inner water tank body 104. Therefore, the connector holder 132 may be connected to the connector pipe 128 and fix the arrangement of the connector body 121.

Referring to FIG. 5, the inner water tank 102 may include a packing 114 mounted in the inner water tank body 104 forming a circumference of the lower hole 106. The packing 114 may be made of a rubber material, for example. The packing 114 may be disposed to contact the connector plate 122 at an upper side and contact the connector holder 132 at a lower side.

The packing 114 may prevent contact between the inner water tank body 104 and the connector body 121. The packing 114 may prevent contact between the inner water tank body 104 and the connector holder 132. The packing 114 may form a seal between the connector plate 122 and a lower wall 105 of the inner water tank body 104. In addition, the packing 114 may form a seal between the connector holder 132 and the lower wall 105 of the inner water tank body 104. That is, the packing 114 may doubly prevent water inside of the inner water tank 102 from leaking outside of the connector 120.

An inner sealer 136 may be disposed at an outer circumference of the connector pipe 128. The inner sealer 136 may seal a space between the connector 120 and the supply pipe 230.

An outer sealer 134 may be disposed at an outer circumference of the connector holder 132. The outer sealer 134 may be disposed to contact one side of the outer water tank 160 and/or the inner shell 180, which will be described hereinafter.

Referring to FIG. 4, the water tank cover 14 may be disposed at the upper side of the inner water tank 102. The water tank cover 14 may be seated on the discharge grill 12. The water tank cover 14 may include the central cover 16 and a peripheral cover 18 disposed at an outer circumference of the central cover 16.

The peripheral cover 18 may be disposed at an upper side of the discharge grill 12, and may maintain an arrangement of the water tank cover 14. The peripheral cover 18 may have a ring-shaped structure, for example. The peripheral cover 18 may be inclined downward as it extends inward in the radial direction. Therefore, when water is supplied to an upper portion thereof, the water may flow toward the central cover 16.

The central cover 16 may have a shape that is convex upward. Therefore, when water is supplied to an upper side of the central cover 16, the water may flow in a direction of an outer circumference of the central cover 16. A water supply hole 20 through which water may be supplied in a direction of the inner water tank 102 may be formed between the central cover 16 and the peripheral cover 18. Water may flow through the water supply hole 20 to an upper side of the handle fixing portion 112 of the handle 108 of the inner water tank 102.

The water tank cover 14 may be spaced upward from the inner water tank 102 and/or the outer water tank 160. Therefore, a force of water pressing the water tank cover 14 downward during the water supply process may not be delivered to the inner water tank 102 or the outer water tank 160.

The outer water tank 160 may be disposed at the outer circumference of the inner water tank 102. The outer water tank 160 may be disposed in contact with the outer circumference of the inner water tank 102. Therefore, condensation water generated at the outer circumference of the inner water tank 102 may be minimized.

An upper end 162 of the outer water tank 160 may be spaced apart from the inner water tank 102. That is, the upper end 162 of the outer water tank 160 may be formed so that a rate of expansion in the radial direction increases as it extends upward.

The outer water tank 160 may also have a cylindrical shape having an open upper side, for example. A through hole 164 through which the connector 120 of the inner water tank 102 may penetrate may be formed in a lower surface of the outer water tank 160. The through hole 164 may be larger than the lower hole 106 of the inner water tank 102.

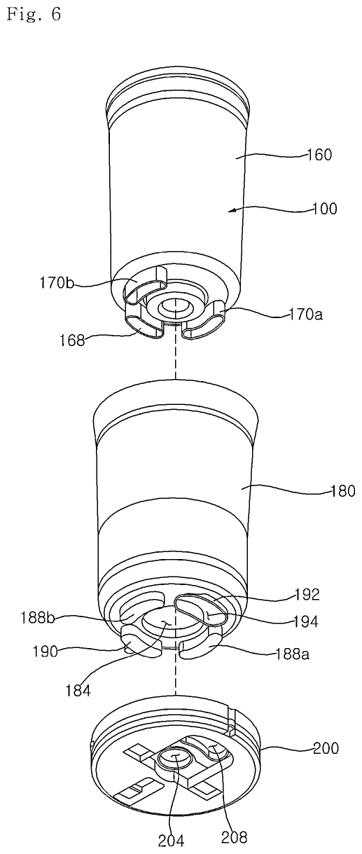

Referring to FIG. 6, in the lower surface of the outer water tank 160, a lower protrusion 166 that protrudes downward around the through hole 164, a pair of first water tank protrusions 170a, 170b that protrudes downward from the lower surface of the outer water tank 160, and a second water tank protrusion 168 that protrudes downward from the lower surface of the outer water tank 160 may be disposed. The lower protrusion 166 may be disposed around the through hole 164. The lower protrusion 166 may extend downward from an inner circumferential end of the lower surface of the outer water tank 160. The lower protrusion 166 may have a ring shaped structure, for example. The outer sealer 134 may be disposed in contact with the inner circumferential surface of the lower protrusion 166.

Referring to FIG. 6, a pair of first water tank protrusions 170a, 170b may be disposed in opposite directions based on the through hole 164. A pair of first water tank protrusions 170a and 170b may transmit a load of the inner water tank 102 and the outer water tank 160 to a weight sensor 212a, 212b of a middle tray 200, which will be described hereinafter. A pair of first water tank protrusions 170a, 170b may directly transmit the load of the inner water tank 102 and the outer water tank 160 to the weight sensor 212a, 212b, or may indirectly transmit through the inner shell 180. The second water tank protrusion 168 may be disposed between the pair of first water tank protrusions 170a and 170b.

The inner shell 180 may be spaced apart from the outer water tank 160. The inner shell 180 may be spaced apart from the water tank 100. The first discharge flow path 32 through which humidified air flows may be formed between the inner shell 180 and the outer water tank 160.

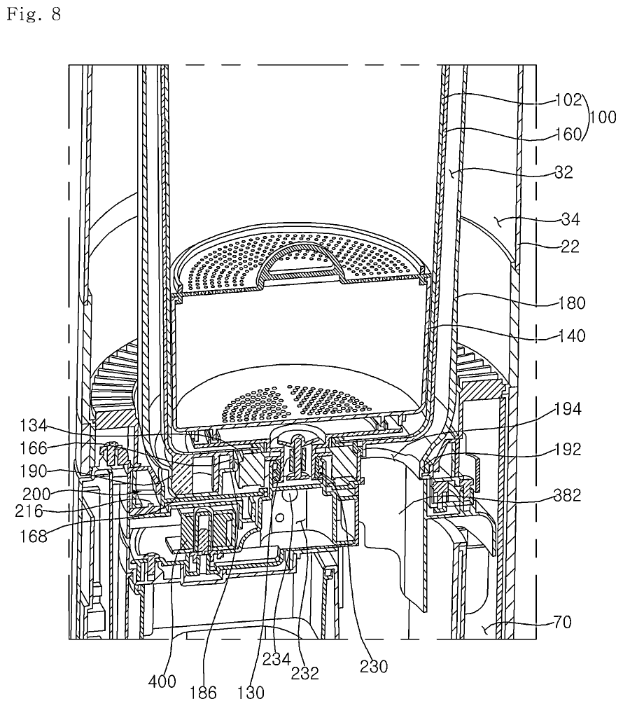

Referring to FIG. 8, the inner shell 180 may be spaced apart from the outer shell 22. The inner shell 180 may form the second discharge flow path 34 through which the filtered air flows between the outer shell 22 and the inner shell 180.

The inner shell 180 may have a cylindrical shape with an open upper side, for example. The inner shell 180 may have a larger diameter than the outer water tank 160. An upper end of the inner shell 180 may have a large radial expansion rate, similar to the upper end 162 of the outer water tank 160.

A shell through hole 184 may be formed in a lower surface of the inner shell 180. The shell through hole 184 may be disposed below the through hole 164 of the outer water tank 160. The connector 120 may be disposed in the shell through hole 184.

The inner shell 180 may be formed of a transparent material, for example. Referring to FIG. 8, an upper protrusion 186 that protrudes upward from a portion at which the shell through hole 184 is formed may be disposed in the inner shell 180. The upper protrusion 186 of the inner shell 180 may be disposed in contact with the lower protrusion 166 of the outer water tank 160.

A size of the shell through hole 184 of the inner shell 180 may be smaller than a size of the through hole 164 of the outer water tank 160. The upper protrusion 186 may be disposed inside of the lower protrusion 166 of the outer water tank 160. That is, an outer circumferential surface of the upper protrusion 186 may face an inner circumferential surface of the lower protrusion 166 of the outer water tank 160. The outer sealer 134 may be disposed at an upper side of the upper protrusion 186.

A pair of first shell protrusions 188a and 188b in which the pair of first water tank protrusions 170a and 170b of the outer water tank 160 are mounted may be disposed in the inner shell 180. The pair of first shell protrusions 188a and 188b may protrude downward from the lower surface of the inner shell 180. Each of the pair of first shell protrusions 188a and 188b forms a space into which the pair of first water tank protrusions 170a and 170b are inserted.

Each of the pair of first shell protrusions 188a and 188b may be disposed at an upper side of the weight sensor 212a, 212b disposed in the middle tray 200. Therefore, the pair of first shell protrusions 188a and 188b may transmit the loads of the inner water tank 102 and the outer water tank 160 to the weight sensor 212a, 212b.

A second shell protrusion 190 on which the second water tank protrusion 168 of the outer water tank 160 may be mounted may be disposed in the inner shell 180. The second shell protrusion 190 may form a space into which the second water tank protrusion 168 is inserted.

Referring to FIG. 8, an exhaust connection pipe 192 may be disposed in the inner shell 180 to guide humidified air discharged from the second humidifying water tank 350 to the first discharge flow path 32. The exhaust connection pipe 192 may extend downward from the lower surface of the inner shell 180. The exhaust connection pipe 192 may have a shape corresponding to an exhaust pipe 382 described hereinafter. The exhaust connection pipe 192 may have an approximate oval shape, for example.

Referring to FIG. 8, a lower end of the exhaust connection pipe 192 may be connected to an upper end of the exhaust pipe 382. The lower end of the exhaust connection pipe 192 may be disposed inside of the upper end of the exhaust pipe 382. The lower end of the exhaust connection pipe 192 may be formed to have a step for that protrudes into the inside of the exhaust pipe 382. An exhaust pipe connection hole 194 opened downward may be formed at the lower end of the exhaust connection pipe 192.

The humidifier may include the middle tray 200 that separates between an area in which the water tank 100 is disposed and an area in which the humidifying module is disposed. The middle tray 200 may detect a level of water stored in the water tank 100. The middle tray 200 may irradiate light to the discharged humidified air.

Referring to FIG. 6, the middle tray 200 may be disposed at the lower side of the water tank 100. The middle tray 200 may be disposed at the upper side of the second humidifying water tank 350 or the first humidifying water tank 300, which will be described hereinafter. The weight sensor 212a, 212b that detects the water level of the water tank 100 by weight may be disposed in the middle tray 200.

Referring to FIG. 8, a lamp 216 that irradiates light toward the first discharge flow path 32 may be disposed in the middle tray 200. The inner shell 180 may be seated on the middle tray 200. The middle tray 200 may support the inner water tank 102 and the outer water tank 160.

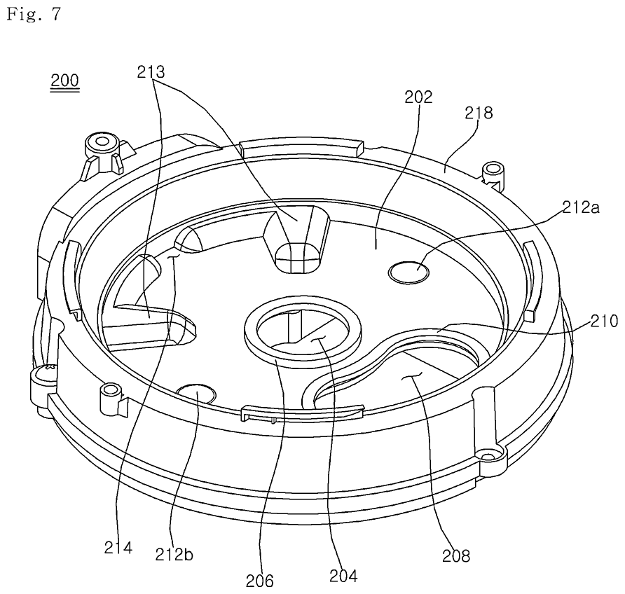

Referring to FIG. 7, the middle tray 200 may include a tray plate 202 and a lamp housing 218 that is disposed around an outer circumference of the tray plate 202 and has the lamp 216 disposed therein. A first hole 204 through which the supply pipe 230 passes may be formed in a first side of the tray plate 202. The first hole 204 may be formed at a center of the tray plate 202. A portion of the supply pipe 230 may be disposed upstream of the first hole 204. The connector 120 of the inner water tank 102 may be connected to the supply pipe 230 disposed at an upper side of the first hole 204.

Referring to FIG. 7, a first flange 206 that protrudes toward an upper side of the tray plate 202 may be disposed around the first hole 204. Therefore, water flowing onto the upper side of the tray plate 202 may be prevented from flowing to a lower side of the middle tray 200.

A second hole 208 through which the humidified air discharged from the second humidifying water tank 350 flows may be formed in a second side of the tray plate 202. A second flange 210 that protrudes upward from the tray plate 202 may be disposed around the second hole 208. The second flange 210 may prevent water flowing onto the upper side of the tray plate 202 from flowing to a lower side of the middle tray 200 through the second hole 208.

The lamp housing 218 may be disposed along a circumference of the tray plate 202. The lamp housing 218 may be formed in a ring shape, for example. The lamp 216 that irradiates light upward may be disposed inside of the lamp housing 218. One side of the lamp housing 218 may be formed of a material that transmits light emitted from the lamp 216, for example.

The middle tray 200 may cover upper sides of the first humidifying water tank 300 and the second humidifying water tank 350. The middle tray 200 may be coupled with the humidifying module housing 410 described hereinafter to form a space in which the first humidifying water tank 300 and the second humidifying water tank 350 may be disposed.

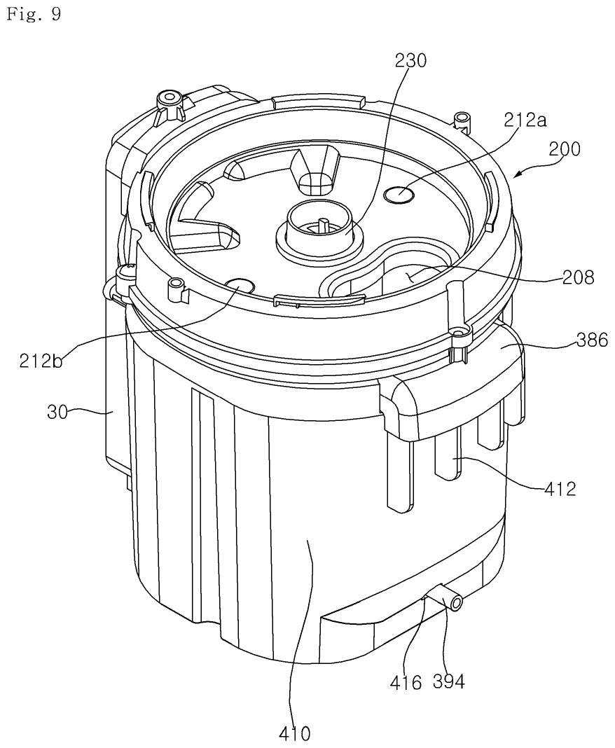

Hereinafter, the humidifying module housing and the middle tray will be described with reference to FIGS. 9 to 10.

Referring to FIG. 9, the humidifier may include the humidifying module housing 410 that forms a space in which the first humidification water tank 300 and the second humidification water tank 350 are disposed, and the middle tray 200 disposed at an upper side of the humidifying module housing 410.

Referring to FIG. 10, a space in which the first humidifying water tank 300 and the second humidifying water tank 350 are disposed may be formed between the humidifying module housing 410 and the middle tray 200. The humidifying module housing 410 may form a space in which the first humidifying water tank 300 and the second humidifying water tank 350 are disposed and may have a shape having an open upper side, for example. The middle tray 200 may cover the open upper side of the humidifying module housing 410.

Referring to FIG. 10, inside the space formed by the humidification module housing 410, the first humidifying water tank 300 that heats water, the second humidifying water tank 350 that is connected to the first humidifying water tank 300 and generates humidified air using heated water, and the supply pipe 230 that supplies water to the first humidifying water tank 300 may be disposed. The exhaust pipe 382 that directs humidified air generated in the second humidifying water tank 350 to the first discharge flow path 32 may be disposed inside of the space formed by the humidifying module housing 410. The exhaust pipe 382 may direct the humidified air generated in the second humidifying water tank 350 and/or the humidified air generated in the first humidifying water tank 300 to the upper side of the middle tray 200.

Referring to FIGS. 9 to 10, an air guide cover 386 may be disposed at one side of a circumferential surface of the humidifying module housing 410. The air guide cover 386 may protrude outward from a first side of the circumferential surface of the humidifying module housing 410.

A plurality of air guide ribs 412 that extends in the upward-downward direction and spaced apart in a direction perpendicular to the upward-downward direction may be disposed in the circumferential surface of the humidifying module housing 410. The air guide rib 412 may be disposed at a lower side of the air guide cover 386.

Referring to FIG. 10, a drain pipe hole 416 through which a drain pipe 394 passes may be formed in a second side of the circumferential surface of the humidifying module housing 410. A drain pipe groove 414, which is recessed downward in an area where the drain pipe 394 is disposed, may be formed in a lower surface of the humidifying module housing 410. A drain pipe 394 may be mounted in the drain pipe groove 414.

The air guide cover 386 may protrude to one side of the circumferential surface of the humidifying module housing 410. The air guide rib 412 may be disposed below the air guide cover 386 of the humidifying module housing 410.

Referring to FIG. 10, the display 30 may be disposed in the circumferential surface of the humidifying module housing 410. The display 30 may be disposed in an opposite direction to which the air guide cover 386 protrudes.

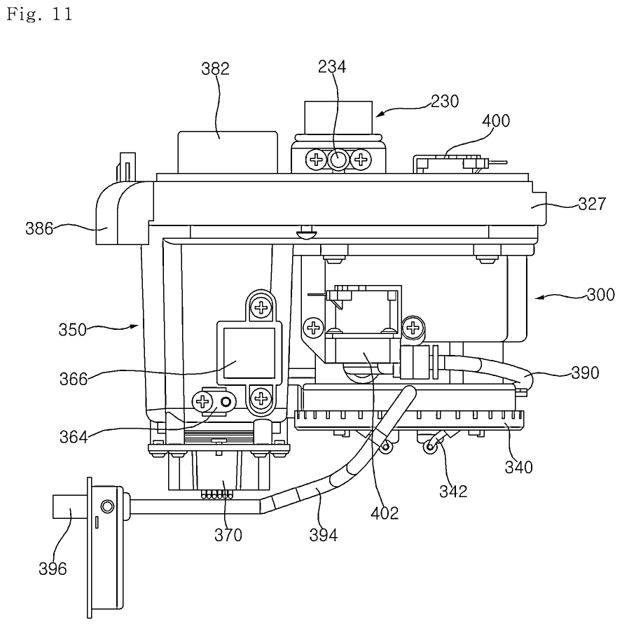

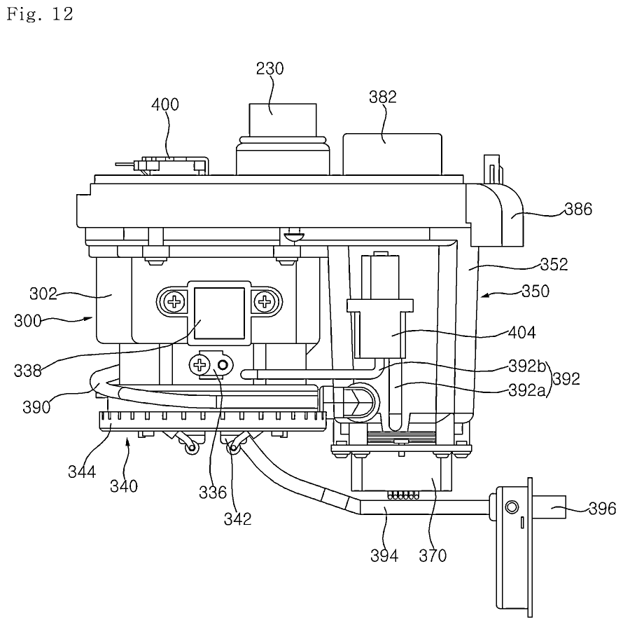

Referring to FIGS. 11 and 12, a drain valve 396 that opens and closes the drain pipe 394 may be disposed at a distal end of the drain pipe 394. The drain valve 396 may open and close the drain pipe 394 depending on its arrangement.

The humidifying module housing 410 may have the display 30 mounted on the second side of the circumferential surface.

The middle tray 200 may be disposed at upper sides of the first humidifying water tank 300 and the second humidifying water tank 350. The middle tray 200 may be disposed at the open upper side of the humidifying module housing 410. The middle tray 200 may cover the open upper side of the humidifying module housing 410.

The water tank 100 may be mounted at the upper side of the middle tray 200. The water tank 100 and the inner shell 180 may be disposed at the upper side of the middle tray 200. Referring to FIG. 9, the weight sensor 212a, 212b that detects the water level of the water tank 100 may be disposed in the upper surface of the middle tray 200.

A second hole 208 may be formed at one side of the upper surface of the middle tray 200 to allow humidified air discharged from the second humidifying water tank 350 to flow therethrough. Some components of the supply pipe 230 may penetrate the first hole 204 formed in the middle tray 200 and protrude toward the upper side of the middle tray 200.

A mounting protrusion 213 that protrudes upward may be disposed in the upper surface of the middle tray 200 to maintain a position of the second shell protrusion 190 of the inner shell 180. The mounting protrusion 213 may be disposed around a fixing groove 214 in which the second shell protrusion 190 is disposed.

Between the middle tray 200 and the humidifying module housing 410, a peripheral wall 327 of a second upper cover 326 described hereinafter may be exposed. Referring to FIG. 10, the middle tray 200 may be disposed at the upper side of the humidifying module housing 410. The middle tray 200 may cover the upper side of the humidifying module housing 410. Therefore, the middle tray 200 may separate an area in which humidified air is generated and an area in which the humidified air flows to be discharged.

A configuration of the supply pipe, the first humidifying water tank, the second humidifying water tank, and the exhaust pipe will be described hereinafter with reference to FIGS. 10 to 16. The humidifier according to embodiments may include the humidifying module that heats water and generates humidified air. The humidifying module may include the first humidifying water tank 300 that heats water, and the second humidifying water tank 350 that generates humidified air using the vibrator 370.

The humidifier may include a first connection pipe 390, and a second connection pipe 392 that connect the first humidifying water tank 300 and the second humidifying water tank 350. The first connection pipe 390 may supply water heated in the first humidifying water tank 300 to the second humidifying water tank 350.

Referring to FIG. 11, a second valve 402 may be disposed in the first connection pipe 390. The second valve 402 may open and close an internal flow path of the first connection pipe 390, so that water heated in the first humidifying water tank 300 may be supplied to the second humidifying water tank 350.

The first humidifying water tank 300 and the second humidifying water tank 350 may be connected through a communication pipe 310 disposed above the first connection pipe 390. Water heated in the first humidifying water tank 300 may be supplied to the second humidifying water tank 350 through the first connection pipe 390. The humidified air generated in the first humidifying water tank 300 may flow into the second humidifying water tank 350 through the communication pipe 310.

Referring to FIG. 12, a pump 404 may be disposed in the second connection pipe 392. When the pump 404 operates, water in the second humidifying water tank 350 may flow to the first humidifying water tank 300.

The humidifier may include a first temperature sensor 336 that detects a temperature of the water stored inside of the first humidifying water tank 300, and a first water level sensor 338 that detects a level of water stored inside of the first humidifying water tank 300. Referring to FIG. 12, the first temperature sensor 336 and the first water level sensor 338 may be disposed at one side of the first humidifying water tank 300.

The humidifier may include a second temperature sensor 364 that detects a temperature of the water stored inside of the second humidifying water tank 350, and a second water level sensor 366 that detects a level of water stored in the second humidifying water tank 350. Referring to FIG. 11, the second temperature sensor 364 and the second water level sensor 366 may be disposed at one side of the second humidifying water tank 350.

The humidifier may include a detection sensor 234 that detects a quality of water existing in the supply pipe 230. Referring to FIG. 11, the detection sensor 234 may be disposed at one side of the supply pipe 230. The detection sensor 234 may detect the quality of the water flowing from the water tank 100. The detection sensor 234 may detect a replacement timing of the water softener 140 disposed in the water tank 100 by detecting the water quality.

The humidifier may include the supply pipe 230 that supplies water stored in the water tank 100 to the first humidifying water tank 300. The supply pipe 230 may be disposed between the water tank 100 and the first humidifying water tank 300. The supply pipe 230 may temporarily store water that is discharged from the water tank 100 and supplied to the first humidifying water tank 300.

A supply chamber 232 in which water may be temporarily stored may be formed in the supply pipe 230. A detection sensor 234 that detects a hardness of the water stored inside may be disposed at one side of the supply pipe 230.

A plurality of components may be coupled to form the supply pipe 230. Referring to FIG. 10, the supply pipe 230 may be formed by coupling a first upper cover 322 and a supply pipe cover 231. The supply pipe cover 231 may have a structure that is disposed at an upper side of the first upper cover 322 and forms a supply chamber 232 therein by coupling with the first upper cover 322. Unlike the drawing, it is also possible that the supply pipe is formed as a single structure.

The supply pipe 230 may include an upper supply pipe 230a connected to the connector 120, a middle supply pipe 230b that extends to a lower side of the upper supply pipe 230a, and a lower supply pipe 230c that extends from a lower portion of the middle supply pipe 230b in a direction perpendicular to the upward-downward direction. The upper supply pipe 230a may be disposed above the middle tray 200. The upper supply pipe 230a may penetrate the first hole 204 of the middle tray 200 and extend upwardly. The middle supply pipe 230b may extend to the lower side of the upper supply pipe 230a and may have a cylindrical shape, for example. A diameter of the middle supply pipe 230b may be larger than a diameter of the upper supply pipe 230a.

The lower supply pipe 230c may extend in a direction perpendicular to the upward-downward direction from one side of the middle supply pipe 230b. The lower supply pipe 230c may form the supply chamber 232 together with the first upper cover 322 disposed at the upper side of the first humidifying water tank 300 disposed below.

The lower supply pipe 230c may be formed between the supply pipe cover 231 and the first upper cover 322. The first upper cover 322 may include a chamber groove 324 recessed downward in an area forming the lower supply pipe 230c.

A first valve 400 may be disposed at a distal end of the lower supply pipe 230c. A flow path formed by the supply pipe cover 231 and the first upper cover 322 may have a narrow flow path shape, and a distal end in which the first valve 400 is disposed.

Depending on the position of the first valve 400, the flow path formed at the distal end of the supply pipe 230 may be opened or closed. The first valve 400 may supply water from the supply pipe 230 to the first humidifying water tank wall 302 or stop supplying water.

The first valve 400 may be disposed at the upper side of the first humidifying water tank 300 to supply water existing in the supply pipe 230 to the first humidifying water tank 300 or stop supplying water. A first supply hole 325 may be formed in the first upper cover 322. Water in the supply chamber 232 may flow toward the first humidifying water tank 300 through the first supply hole 325. The first valve 400 may supply water stored in the supply chamber 232 to the first humidifying water tank 300 by opening and closing the first supply hole 325.

The detection sensor 234 may be disposed in the supply pipe 230 to detect the quality of water inside of the supply chamber 232. The detection sensor 234 may be disposed at one side of the middle supply pipe 230b. The detection sensor 234 may be disposed at an upper portion of the middle supply pipe 230b.

Referring to FIG. 10, the detection sensor 234 may be disposed at an upper side of the middle supply pipe 230b, and may quickly detect the quality of water supplied from the water tank 100. That is, when the water in the supply chamber 232 falls and the water in the water tank 100 flows in, the detection sensor 234 may detect the quality of the water flowing in from the water tank 100.

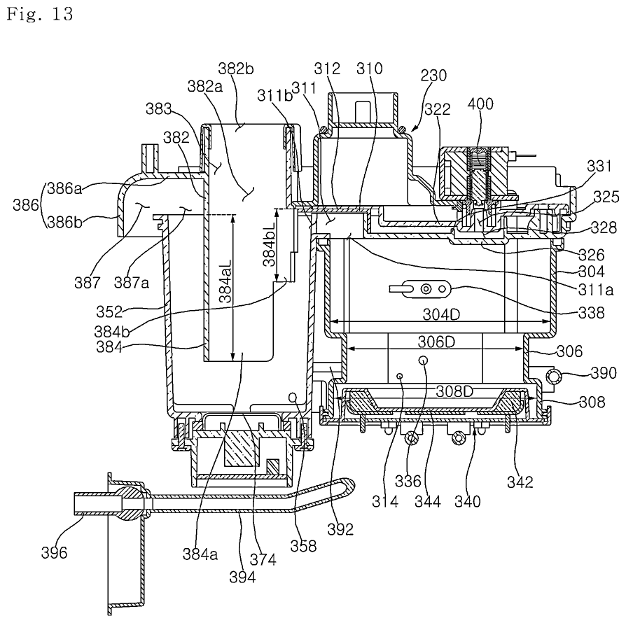

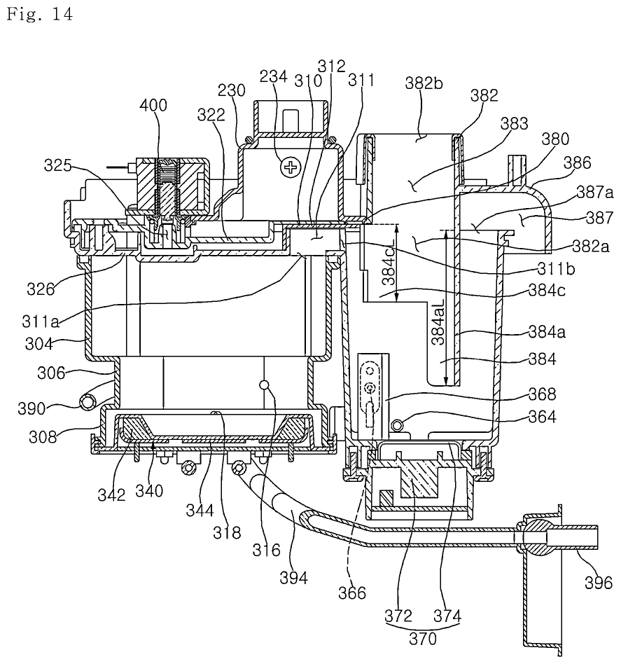

The first humidifying water tank 300 may include a first chamber 300a that forms a space in which water is stored and the water is heated. Referring to FIGS. 13 and 14, the first humidifying water tank 300 may include a first humidifying water tank wall 302 that forms the first chamber 300a, and a heater 340 that is disposed at a lower side of the first humidifying water tank wall 302 and heats the water inside of the first humidifying water tank wall 302.

The first humidifying water tank wall 302 may have a cylindrical shape, for example, in which water is stored. The first humidifying water tank wall 302 may have an open lower side, and the heater 340 may be disposed at a lower side of the first humidifying water tank wall 302.

Referring to FIGS. 13 to 14, the first humidifying water tank wall 302 may include a lower water tank wall 308, a middle water tank wall 306, and an upper water tank wall 304. The lower water tank wall 308, the middle water tank wall 306, and the upper water tank wall 304 may be disposed side by side from a lower side to an upper side.

The heater 340 may be disposed on the lower water tank wall 308. The heater 340 may protrude inside of the lower water tank wall 308. However, the heater 340 may be spaced radially inward from an inner circumferential surface of the lower water tank wall 308. The lower water tank wall 308 may be spaced apart from the heater 340 disposed inside at a certain or predetermined distance. A drain hole 318 may be formed at one side of the lower water tank wall 308.

Referring to FIGS. 13 and 14, the heater 340 may include a heating element 342 that receives electricity to generate heat, and a heating plate 344 disposed in contact with the heating element 342. The heating element 342 may be formed in a ring shape having one side open, for example. The heating element 342 may be disposed inside of the lower water tank wall 308.

The heating plate 344 may be disposed at an upper side of the heating element 342 and transmit the heat generated by the heating element 342 to the water inside of the first humidifying water tank 300. The heating plate 344 may cover the heating element 342. Some components of the heating plate 344 may protrude inside of the lower water tank wall 308 to cover the heating element 342. The heating plate 344 disposed inside of the lower water tank wall 308 may be spaced apart from an inner circumferential surface of the lower water tank wall 308.

Referring to FIG. 13, the middle water tank wall 306 may be disposed at an upper side of the lower water tank wall 308. A diameter 306d of the middle water tank wall 306 may be larger than a diameter 308d of the lower water tank wall 308. The diameter 306d of the middle water tank wall 306 may be smaller than a diameter 304d of the upper water tank wall 304.

The middle water tank wall 306 may have a small diameter, thereby forming a space where the second valve 402 may be disposed inside of the humidifying module housing 410. The middle water tank wall 306 may have a small diameter, thereby forming a space where the connection pipe 390 may be disposed inside of the humidifying module housing 410.

Referring to FIGS. 12 to 13, the first temperature sensor 336 may be disposed at one side of the middle water tank wall 306. In the one side of the middle water tank wall 306, a recovery inlet hole 314 through which water flows in from the second connection pipe 392 may be formed. An outlet hole 316 through which water flows out to the first connection pipe 390 may be formed at one side of the middle water tank wall 306.

The outlet hole 316 may be disposed at a higher position than the recovery inlet hole 314. The first temperature sensor 336 may be disposed at a higher position than the recovery inlet hole 314. The outlet hole 316 may be disposed at the same as or a higher position than the first temperature sensor 336.

Therefore, the first temperature sensor 336 may detect the temperature that is varied as the water supplied to the first humidifying water tank 300 is heated. In addition, the first temperature sensor 336 may detect the temperature of water stored in the first chamber 300a of the first humidifying water tank 300 after a portion of the water stored inside of the first humidifying water tank 300 is supplied to the second humidifying water tank 350.

The first temperature sensor 336 may detect a temperature change inside of the first humidifying water tank 300. The first temperature sensor 336 may detect an abnormal operation of the heater 340 inside of the first humidifying water tank 300.

The upper water tank wall 304 may extend to an upper side of the middle water tank wall 306. The diameter 304d of the upper water tank wall 304 may be larger than the diameter 306d of the middle water tank wall 306. A length of the upper water tank wall 304 extending in the upward-downward direction may be longer than a length of the middle water tank wall 306 extending in the upward-downward direction. A size of the internal space formed by the upper water tank wall 304 may be larger than a size of the internal space formed by the middle water tank wall 306 and the lower water tank wall 308.

Referring to FIGS. 12 and 13, a first water level sensor 338 may be disposed at one side of the upper water tank wall 304. The first water level sensor 338 may be disposed above the first temperature sensor 336. The first water level sensor 338 may detect the water level inside of the first humidifying water tank 300. The first water level sensor 338 may detect a normal water level of the first humidifying water tank 300. The normal water level of the first humidifying water tank 300 may refer to an area between an upper end where the water supplied to the first humidifying water tank 300 does not exceed a set or predetermined water level, and a lower end which is a minimum level where water must exist to operate the heater 340.

The first humidifying water tank 300 may include the upper cover 322, 326 disposed at the upper side of the first humidifying water tank wall 302. The upper cover 322, 326 may be disposed at the upper side of the upper water tank wall 304.

The upper cover 322, 326 may cover at least a portion of the upper side of the first humidifying water tank wall 302. The upper cover 322, 326 may include the first upper cover 322, and the second upper cover 326 disposed at the lower side of the first upper cover 322.

Referring to FIGS. 13 and 14, the first upper cover 322 may be disposed at the upper side of the second upper cover 326. The first upper cover 322 may partition the first humidifying water tank wall 302 and the supply pipe 230. The first upper cover 322 may form one side of the supply chamber 232 that forms the inside of the supply pipe 230.

Referring to FIGS. 13 and 14, the first upper cover 322 may include a first supply hole 325 through which the water stored in the supply chamber 232 flows. The first valve 400 may be disposed at an upper side of the first supply hole 325, and may open and close the first supply hole 325. The first upper cover 322 may be spaced upward from the upper end of the upper water tank wall 304.

The first upper cover 322 may be connected to the exhaust pipe 382 described hereinafter. The first upper cover 322 may be formed as one body with the exhaust pipe 382. The first upper cover 322 may have a smaller area than the second upper cover 326.

The first upper cover 322 may be spaced apart from the second upper cover 326. That is, the first upper cover 322 may be spaced apart upward from the second upper cover 326.

A portion of the first upper cover 322 may form a portion of the supply pipe 230. The first upper cover 322 may form the chamber groove 324 that is recessed downward in the area forming the supply pipe 230.

Referring to FIGS. 13 and 14, the second upper cover 326 may cover the first supply hole 325 formed in the first upper cover 322. A second supply hole 330 may be formed in the second upper cover 326 to direct water flowing through the first supply hole 325 to the first humidifying water tank 300. The second supply hole 330 may be spaced apart from the first supply hole 325 in a direction perpendicular to the upward-downward direction.

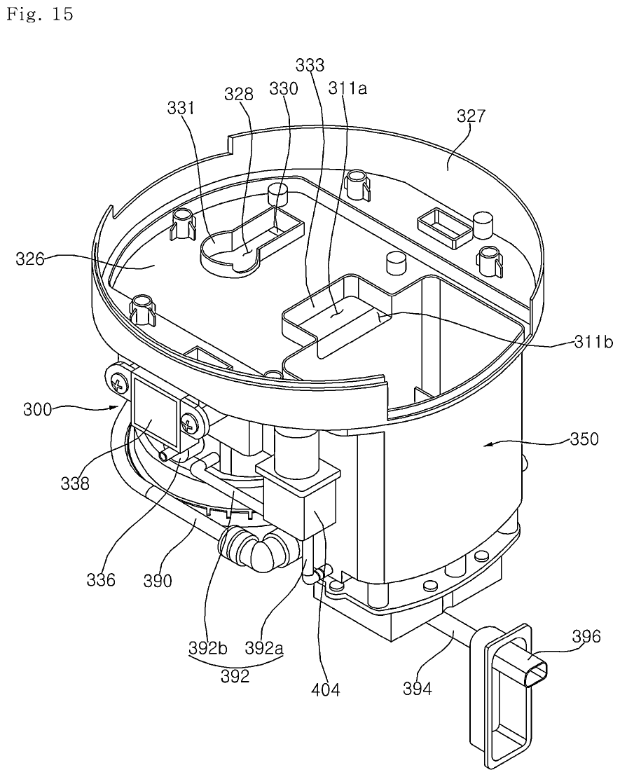

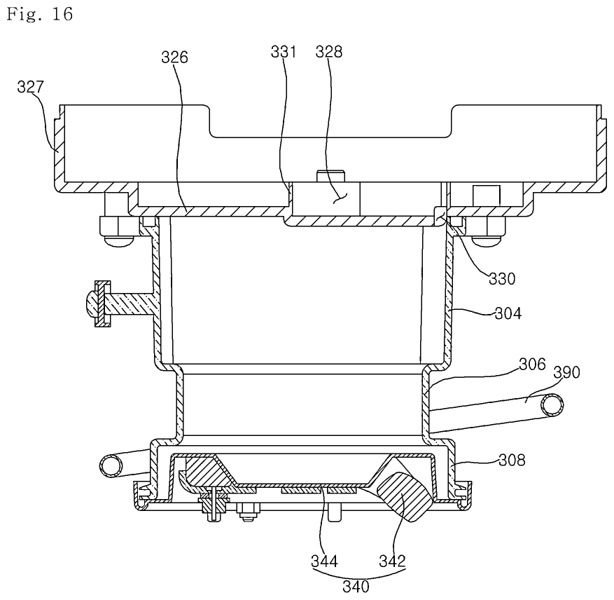

Referring to FIGS. 15 and 16, a supply flow path 328 may be formed between the second upper cover 326 and the first upper cover 322, so that water flowing into the first supply hole 325 flows to the second supply hole 330. A supply flow path rib 331 that protrudes upward may be disposed in the second upper cover 326 to form the supply flow path 328. The supply flow path rib 331 may protrude toward the upper side of the second upper cover 326 and may be disposed in contact with a lower surface of the first upper cover 322.

The supply flow path 328 may extend in a direction different from a direction in which the chamber groove 324 extends. In one embodiment, the direction in which the supply flow path 328 extends may be perpendicular to the direction in which the chamber groove 324 extends.

Referring to FIG. 16, the second supply hole 330 may be formed in an area where the peripheral wall of the first humidifying water tank 300 is located. Therefore, when the water flowing in the supply flow path 328 flows into the first humidifying water tank 300 through the second supply hole 330, it may flow downward along a circumferential wall of the first humidifying water tank 300. This may reduce the noise of falling water supplied to the first humidifying water tank 300.

Referring to FIGS. 13 to 14, a first communication hole 311a may be formed in the second upper cover 326. The first communication hole 311a may connect the first humidifying water tank 300 and the second humidifying water tank 350. That is, humidified air generated in the first humidifying water tank 300 may flow to the second humidifying water tank 350 through the first communication hole 311a.

The first communication hole 311a may be open in the upward-downward direction. Therefore, the humidified air generated by the heater 340 inside of the first humidifying water tank 300 may flow upward through the first communication hole 311a.

The second upper cover 326 may include an upper rib 333 that extends upward around the first communication hole 311a. The upper rib 333 may protrude upward around the second upper cover 326 where the first communication hole 311a is formed.

An upper cover 312 may be disposed at the upper side of the second upper cover 326. The upper cover 312 may be connected to the upper rib 333. The upper cover 312, together with the upper rib 333, may form a communication flow path 311 therein.

The communication flow path 311 may connect the first communication hole 311a formed in the first humidifying water tank 300 and the second communication hole 311b formed in the second humidifying water tank 350. The communication flow path 311 may be disposed at the upper side of the first humidifying water tank 300. Therefore, the humidified air that is generated in the first humidifying water tank 300 may flow to the communication flow path 311 through the first communication hole 311a.

The communication flow path 311 may be formed by the upper rib 333 of the second upper cover 326 and the upper cover 312. The communication flow path 311 may extend in a direction horizontal to the second communication hole 311b.

A second chamber 350a may be formed inside of the second humidifying water tank 350 to store water and atomize the water. Referring to FIGS. 13 to 14, the second humidifying water tank 350 may include a second humidifying water tank wall 352 that forms the second chamber 350a, and the vibrator 370 that is disposed at a lower side of the second humidifying water tank wall 352 and vibrates to atomize the water inside of the second humidifying water tank wall 352.

The second humidifying water tank wall 352 may have a pillar shape forming a space therein, for example. The vibrator 370 may be disposed at the lower side of the second humidifying water tank wall 352. The second humidifying water tank wall 352 may have a shape a cross-sectional area of which in the horizontal direction increases as it extends toward an upper side. An upper end of the second humidifying water tank wall 352 may be higher than the upper end of the first humidifying water tank wall 302.

The vibrator 370 may be disposed at a lower surface of the second humidifying water tank wall 352. Referring to FIG. 13, an inlet hole 358 through which water of the first humidifying water tank wall 302 flows in may be formed at one side of the second humidifying water tank wall 352. In one side of the second humidifying water tank wall 352, a recovery discharge hole 360 through which water stored inside of the second humidifying water tank 350 flows into the first humidifying water tank 300 may be formed.

The inlet hole 358 may be formed at a lower position than the outlet hole 316 formed in the first humidifying water tank wall 302. The recovery discharge hole 360 may be formed at a lower position than the inlet hole 358.

Referring to FIG. 13, the vibrator 370 may be disposed in or at the lower surface of the second humidifying water tank 350. In one side of the second humidifying water tank wall 352, a recovery groove 361 forming a space in the circumferential direction may be formed in an area where the recovery discharge hole 360 is formed. The recovery groove 361 may be formed at one side of the vibrator 370. That is, the recovery groove 361 may be formed at one side of the vibrator 370 disposed in the lower surface of the second humidifying water tank 350. That is, the recovery groove 361 may form a space at a lower end of an inner side of the second humidifying water tank wall 352. The recovery discharge hole 360 may be formed at a lower position than the recovery inlet hole 314 formed in the first humidifying water tank wall 302.

Referring to FIG. 14, a second temperature sensor 364 may be disposed at one side of a circumferential surface of the second humidifying water tank 350. The second temperature sensor 364 may be disposed at a higher position than the recovery discharge hole 360. The second temperature sensor 364 may be disposed at a position lower than or equal to the inlet hole 358.

The second temperature sensor 364 may detect a temperature of the water supplied into the second humidifying water tank 350. Therefore, the second temperature sensor 364 may detect whether water of a set or predetermined temperature or higher is supplied into the second humidifying water tank 350.

Referring to FIGS. 11 and 14, the second water level sensor 366 may be disposed at one side of a peripheral wall of the second humidifying water tank 350. The second water level sensor 366 may detect the level of water inside of the second humidifying water tank 350. The second water level sensor 366 may detect a lowest water level inside of the second humidifying water tank 350 at which the vibrator 370 may operate. In addition, the second water level sensor 366 may detect an amount of water stored inside of the second humidifying water tank 350. The second water level sensor 366 may detect an optimal water level for operation of vibrator 370.

Referring to FIG. 14, a water level sensor cover 368 may be disposed inside of the second humidifying water tank 350. The water level sensor cover 368 may be disposed at a certain or predetermined distance from the second water level sensor 366. The water level sensor cover 368 may be disposed between the second water level sensor 366 and the vibrator 370. The water level sensor cover 368 may protrude upward from the lower surface of the second humidifying water tank 350. Even if the water level inside of the second humidifying water tank 350 is varied due to the vibrator 370, the second water level sensor 366 may detect the water level more accurately using the water level sensor cover 368.

A second communication hole 311b may be formed at an upper end of the peripheral wall of the second humidifying water tank 350. The second communication hole 311b may be formed at the upper end of the peripheral wall of the second humidifying water tank 350. The communication hole 311b may be open in a direction in which the first humidifying water tank 300 is disposed.

Referring to FIGS. 13 and 14, the second communication hole 311b may be connected to the communication flow path 311. The second communication hole 311b may be open in the horizontal direction.

Two vibrators 370 may be disposed in or at the lower surface of the second humidifying water tank 350. Two vibrators 370 may be spaced apart from each other in a direction perpendicular to the upward-downward direction.

The vibrator 370 may include a vibrating element 372 that generates vibration, and a vibrating element cover 374 disposed at an upper side of the vibrating element 372. The vibrating element cover 374 is disposed to contact the water stored inside of the second humidifying water tank 350. The vibrating element cover 374 may transmit the vibration generated in the vibrating element 372 to the water stored inside of the second humidifying water tank 350. The vibrator 370 generates humidified air using water stored in the second humidifying water tank 350.

Referring to FIGS. 13 to 14, the second humidifying water tank 350 may include a humidifying water tank cover 380 disposed at the upper side of the second humidifying water tank wall 352. The humidifying water tank cover 380 may supply humidified air generated in the second humidifying water tank 350 to the first discharge flow path 32.

The humidifying water tank cover 380 may include the exhaust pipe 382 that sends humidified air upward. The exhaust pipe 382 may extend upward from the humidifying water tank cover 380. The exhaust pipe 382 may have a roughly oval pillar shape, for example.

Referring to FIGS. 13 and 14, the exhaust pipe 382 may be disposed at an upper side of a pair of vibrators 370. Therefore, humidified air generated in the vibrator 370 may quickly flow to the exhaust pipe 382. In addition, when the water stored in the second chamber 350a of the second humidifying water tank 350 is splashed upward by the vibrator 370, it may move into the exhaust pipe 382.

The upper end of the exhaust pipe 382 may be disposed in contact with the middle tray 200 (see FIG. 8). The upper end of the exhaust pipe 382 may be in direct contact with the middle tray 200, or may be disposed in indirect contact through a separate sealing member 388.

An exhaust pipe inlet 382a (or exhaust hole) may be formed at a lower end of the exhaust pipe 382. An exhaust pipe outlet 382b may be formed at the upper end of the exhaust pipe 382. The exhaust pipe 382 may have an exhaust pipe flow path 383 formed between the exhaust pipe inlet 382a and the exhaust pipe outlet 382b.

An air supply hole 387 may be formed at one side of the humidifying water tank cover 380. External air may flow into the second humidifying water tank 350 through the air supply hole 387. The air supply hole 387 may have a shape that is open upward, for example.

The humidifying water tank cover 380 may include the air guide cover 386 that supplies air flowing through the blower flow path 70 to the second humidifying water tank 350. The air guide cover 386 allows a portion of the air flowing to the outside of the humidifying module housing 410 to flow to the inside of the second humidifying water tank 350 through the air supply hole 387. The air guide cover 386 may guide air flowing to the outside of the second humidifying water tank 350 to flow to the inside of the second humidifying water tank 350.

The air guide cover 386 may be spaced upward from the air supply hole 387 and extend in a horizontal direction from the exhaust pipe 382. The air guide cover 386 may extend from a peripheral wall of the exhaust pipe 382, and may be disposed at a position spaced upward from the upper end of the second humidifying water tank wall 352.

Referring to FIG. 10, the air guide cover 386 may extend to the outside of the circumferential surface of the humidifying module housing 410. Therefore, the air guide cover 386 may guide a portion of the air flowing upward along the blower flow path 70 to flow into the second humidifying water tank 350.

Referring to FIGS. 13 and 14, the air guide cover 386 may include a horizontal wall 386a that extends in a horizontal direction from the exhaust pipe 382, and a vertical wall 386b that extends downward from a distal end of the horizontal wall 386a. The horizontal wall 386a may be spaced apart upward from the air supply hole 387 and the upper end of the second humidifying water tank wall 352.

The vertical wall 386b may be spaced outward from a peripheral wall of the second humidifying water tank 350. The vertical wall 386b may be spaced outward from the peripheral wall of the humidifying module housing 410. A lower end of the vertical wall 386b may be located lower than the upper end of the second humidifying water tank wall 352.

A portion of the air flowing through the blower flow path 70 may flow upward into the space between the humidifying module housing 410 and the vertical wall 386b, flow to the upper side of the second humidifying water tank 350 along the horizontal wall 386a, and then flow to a lower portion of the second chamber 350a of the second humidifying water tank 350 along the air supply hole 387.

The air inlet flow path 387 through which air flows may be formed at a lower side of the air guide cover 386. The air inlet flow path 387 may be disposed above the communication flow path 311. The air supply hole 387 may be disposed above the communication flow path 311.

The humidifying water tank cover 380 may include a lower extension wall 384 that protrudes from the humidifying water tank cover 380 toward the inside of the second humidifying water tank 350. The lower extension wall 384 may extend downward from the humidifying water tank cover 380. The lower extension wall 384 may protrude downward from an area where the exhaust pipe 382 is formed.

Referring to FIGS. 13 and 14, the lower extension wall 384 may be disposed between the exhaust pipe inlet 382a and the air supply hole 387. When viewed from above, the lower extension wall 384 may have a bent shape in a direction of the exhaust pipe inlet 382a. Accordingly, the air flowing into the second humidifying water tank 350 through the air supply hole 387 may flow along the lower portion of the second chamber 350a and the inner circumferential surface of the second humidifying water tank wall 352.

The lower extension wall 384 may extend downward between the exhaust pipe inlet 382a and the air supply hole 387. The lower extension wall 384 may allow air flowing into the second humidifying water tank 350 through the air supply hole 387 to flow to the lower portion of the second chamber 350a.

The lower extension wall 384 may not be disposed in the direction in which the second communication hole 311b is formed. That is, the lower extension wall 384 may not be disposed in the direction in which the second communication hole 311b is open. Therefore, humidified air flowing into the second humidifying water tank 350 through the second communication hole 311b may flow to the exhaust pipe inlet 382a of the exhaust pipe 382.

The lower extension wall 384 may include a first lower extension wall 384a that extends downward from the exhaust pipe 382 at a portion at which the air supply hole 387 is formed, a second lower extension wall 384b disposed at a first side of the first lower extension wall 384a, and a third lower extension wall 384c disposed at a second of the first lower extension wall 384a. The second lower extension wall 384b and the third lower extension wall 384c may be disposed in opposite directions. The second lower extension wall 384b and the third lower extension wall 384c may face each other.

Referring to FIGS. 13 and 14, a length 384bl, 384cl of each of the second lower extension wall 384b and the third lower extension wall 384c that protrudes downward from the humidifying water tank cover 380 may be formed shorter than a length 384al of the first lower extension wall 384a that extends downward from the humidifying water tank cover 380. A lower end of the first lower extension wall 384a may be formed lower than an upper end of the water level sensor cover 368. A lower end of each of the second lower extension wall 384b and the third lower extension wall 384c may be formed higher than the upper end of the water level sensor cover 368. The water level sensor cover 368 may be disposed at a lower side of the second lower extension wall 384b or the third lower extension wall 384c.

The lower end of the first lower extension wall 384a may be located lower than the lower end of the second lower extension wall 384b or the lower end of the third lower extension wall 384c. In an area facing the second communication hole 311b, a hole through which humidified air flowing from the second communication hole 311b flows into the exhaust pipe 382 may be formed between the second lower extension wall 384b and the third lower extension wall 384c. The humidifying water tank cover 380 may be formed as one body with the first upper cover 322.

The first connection pipe 390 supplies water from the first humidifying water tank 300 to the second humidifying water tank 350. The first connection pipe 390 may have a first side connected to the first humidifying water tank 300, and a second side connected to the second humidifying water tank 350. The first connection pipe 390 may connect the outlet hole 316 of the first humidifying water tank 300 and the inlet hole 358 of the second humidifying water tank 350. The first connection pipe 390 may be disposed lower downward from the outlet hole 316 to the inlet hole 358.

The first connection pipe 390 may extend along a circumference of the first humidifying water tank wall 302. The inlet hole 358 and the outlet hole 316 may be disposed in different directions. Therefore, the first connection pipe 390 may extend along the circumference of the first humidifying water tank wall 302.

The first connection pipe 390 may be longer than the second connection pipe 392. The second valve 402 may be disposed in the first connection pipe 390. The second valve 402 may be disposed closer to the first humidifying water tank 300 than the second humidifying water tank 350. The second valve 402 may be disposed closer to the outlet hole 316 than the inlet hole 358.

The second connection pipe 392 supplies water from the second humidifying water tank 350 to the first humidifying water tank 300. The pump 404 may be disposed in the second connection pipe 392. The second connection pipe 392 may connect the recovery discharge hole 360 of the second humidifying water tank wall 352 and the recovery inlet hole 314 of the first humidifying water tank wall 302.

The recovery discharge hole 360 may be located lower than the recovery inlet hole 314. The pump 404 may be located above the recovery discharge hole 360 and the recovery inlet hole 314.

The second connection pipe 392 may include a pump inlet pipe 392a that connects the second humidifying water tank 350 and the pump 404, and a pump outlet pipe 392b that connects the pump 404 and the first humidifying water tank 300. The pump 404 may be disposed in or at one side of the second humidifying water tank 350.

The humidifier may include the drain pipe 394 that drains the water in the first humidifying water tank 300, and the drain valve 396 that is disposed at a distal end of the drain pipe 394 and opens and closes the drain pipe 394. Referring to FIG. 11, the drain pipe 394 may be connected to one side of the first humidifying water tank 300. The drain pipe valve 396 may be disposed at the distal end of the drain pipe 394.

The drain pipe 394 may discharge water stored in the first humidifying water tank 300 to the outside. Referring to FIG. 10, the drain pipe 394 may extend to the outside of the humidifying module housing 410.

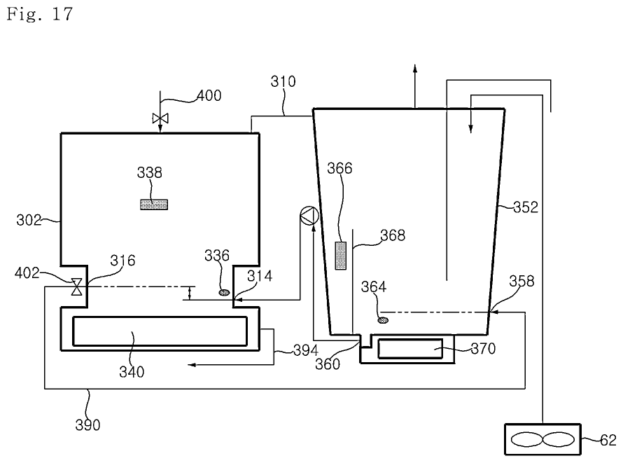

Various sensors and valves disposed in each of the first humidifying water tank 300 and the second humidifying water tank 350, and operation of the first humidifying water tank 300 and the second humidifying water tank 350 will be explained hereinafter with reference to FIG. 17. The first humidifying water tank 300 heats the water supplied from the water tank 100. Water of the water tank 100 may be supplied to the upper side of the first humidifying water tank 300. The first valve 400 may open the supply pipe 230 so that water may be supplied to the first humidifying water tank 300.

The first valve 400 may operate based on the water level detected by the first water level sensor 338. The first valve 400 may open the supply pipe 230, when the water level detected by the first water level sensor 338 is lower than a set or predetermined water level.

The first valve 400 may close the supply pipe 230 when the water level detected by the first water level sensor 338 is a set or predetermined water level or higher. When the second valve 402 opens the first connection pipe 390, the first valve 400 may close the supply pipe 230. Therefore, the water flowing through the first connection pipe 390 may be water that has been completely heated in the first humidifying water tank 300.

The first valve 400 may open the supply pipe 230, when the water quality detected by the detection sensor 234 is a set or predetermined level or higher. The detection sensor 234 may measure the water quality by measuring an electrical conductivity of water. That is, a concentration of ions may be detected by measuring the electrical conductivity of water. Therefore, water, which has improved water quality, that passed through the water softener 140 may be supplied to the first humidifying water tank 300.

When the water is supplied to the first humidifying water tank 300 to a certain or predetermined level and the first valve 400 closes the supply pipe 230, the heater 340 may operate. The heater 340 heats the water stored in the first humidifying water tank 300. The humidified air generated by operation of the heater 340 may flow to the second humidifying water tank 350 through the communication pipe 310.

When the heater 340 operates, the fan 62 may operate. That is, when the heater 340 heats the water stored in the first humidifying water tank 300, the fan 62 operates to supply air to the second humidifying water tank 350. The fan 62 may supply air to the second humidifying water tank 350 to cool the inside of the second humidifying water tank 350.

The heater 340 may operate until the temperature of the water detected by the first temperature sensor 336 reaches 100 degrees, for example. The water stored in the first humidifying water tank 300 may be heated to a boiling point and sterilized. When the temperature of the water detected by the first temperature sensor 336 reaches 100 degrees, the second valve 402 may open the first connection pipe 390. After the temperature of the water detected by the first temperature sensor 336 reaches 100 degrees, the second valve 402 may open the first connection pipe 390.

The first temperature sensor 336 may be disposed at a position equal to or lower than the outlet hole 316. Therefore, the temperature of the water remaining after the water in the second humidifying water tank 350 is discharged through the first connection pipe 390 may be detected.

When the second valve 402 is opened, the water stored in the first humidifying water tank 300 flows to the second humidifying water tank 350 due to gravity. When the second valve 402 is opened, water may move until the water levels in the first humidifying water tank 300 and the second humidifying water tank 350 become the same. When the second valve 402 is opened, the water level in the first humidifying water tank 300 may be lowered to a height of the outlet hole 316 formed in the first humidifying water tank 300.

When the second water level sensor 366 is lower than an optimal height at which the vibrator 370 of the second humidifying water tank 350 can operate, the second valve 402 opens the first connection pipe 390. When a water level difference between the first humidifying water tank 300 and the second humidifying water tank 350 detected by the first water level sensor 338 and the second water level sensor 366 is formed, the second valve 402 opens the first connection pipe 390.

The second valve 402 may be opened for a set or predetermined time. That is, the second valve 402 may be opened for a set or predetermined time considering the time when the water levels of the first humidifying water tank 300 and the second humidifying water tank 350 become the same. When the set or predetermined time elapses, the first connection pipe 390 may be closed. Considering the time during which water in the first humidifying water tank 300 flows to the second humidifying water tank 350, the second valve 402 may be opened for a set or predetermined time.

The fan 62 may operate while the second valve 402 is opened. By operating the fan 62, the air flowing into the second humidifying water tank 350 may cool the water flowing into the second humidifying water tank 350 through the first connection pipe 390.

The second temperature sensor 364 detects the temperature of the water stored in the second humidifying water tank 350. The second temperature sensor 364 may detect the temperature of water flowing into the second humidifying water tank 350 through the inlet hole 358. The vibrator 370 may operate when the temperature of the water detected by the second temperature sensor 364 is a set or predetermined temperature or lower. The set or predetermined temperature at which the vibrator 370 operates may be set in consideration of preventing damage to the vibrator 370. The second temperature sensor 364 may be disposed at the same height as the inlet hole 358 or at a lower height than the inlet hole 358. Therefore, the temperature of water flowing in through the inlet hole 358 may be detected.

The second water level sensor 366 may detect the water level of the second humidifying water tank 350. The second water level sensor 366 may detect the lowest water level of the second humidifying water tank 350 at which the vibrator 370 does not operate. If the water level of the second humidifying water tank 350 detected by the second water level sensor 366 is lower than a set or predetermined water level, operation of the vibrator 370 may be stopped.

The lowest water level at which operation is stopped may be determined based on the level of water stored in the second humidifying water tank 350 compared to the vibration level of the vibrator 370. The second water level sensor 366 may detect upper and lower water levels at which the operation of the vibrator 370 can be optimal, at a position where the water in the second humidifying water tank 350 is higher than the lowest water level at which the vibrator 370 stops operating. In the second humidifying water tank 350, the water level sensor cover 368 may be disposed between the second water level sensor 366 and the vibrator 370, so that water level may be stably detected even when the vibrator 370 operates.

The vibrator 370 may operate when the water level detected by the second water level sensor 366 is a set or predetermined water level or higher. The vibrator 370 may include two vibration elements 372. Therefore, two vibration elements 372 may operate individually. Further, the two vibration elements 372 may operate selectively.

When the vibrator 370 operates, the fan 62 may operate. Therefore, the humidified air generated by the vibrator 370 may be discharged to the outside of the humidifier together with the air flowing from the second humidifying water tank 350 to the first discharge flow path 32 by the fan 62. The fan 62 may activate the flow of humidified air generated by the vibrator 370.

The vibrator 370 and the heater 340 may operate simultaneously. The humidified air generated in the first humidifying water tank 300 may flow to the first discharge flow path 32 through the second humidifying water tank 350, and the humidified air generated in the second humidifying water tank 350 may also flow to the first discharge flow path 32.

The pump 404 pumps water from the second humidifying water tank 350 to the first humidifying water tank 300. The pump 404 may operate after the operation of the vibrator 370 is stopped. The pump 404 may operate after the second valve 402 closes the first connection pipe 390. When the pump 404 operates, the first valve 400 closes the supply pipe 230. When the pump 404 operates, operation of the fan 62 may be stopped.

The recovery discharge hole 360 may be formed at one side of the height at which the vibrator 370 is located. The recovery discharge hole 360 may be disposed at a lower position than the inlet hole 358 formed in the second humidifying water tank 350. The pump 404 may be disposed at a higher position than a position at which the recovery discharge hole 360 and the recovery inlet hole 314 are formed. Therefore, water of the second humidifying water tank wall 352 may be suctioned in, and water may be supplied to the first humidifying water tank 300.

The pump 404 may operate in consideration of the water level of the first humidifying water tank 300 detected by the first water level sensor 338 and the water level of the second humidifying water tank 350 detected by the second water level sensor 366. When the water level in the first humidifying water tank 300 is an optimal level, operation of the pump 404 may be prevented.

The water stored in the first humidifying water tank 300 may be discharged to the outside through the drain pipe 394. When the drain pipe valve 396 opens the drain pipe 394, the water stored in the first humidifying water tank 300 may be discharged to the outside. The drain hole 318 formed in the first humidifying water tank 300 may be disposed at a position at which the heater 340 is disposed. The water stored between the heater 340 and the first humidifying water tank 300 may flow into the drain pipe 394 through the drain hole 318.

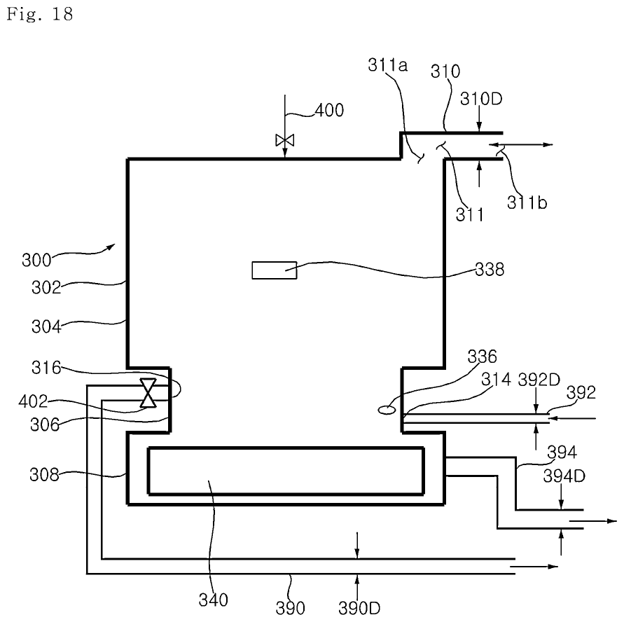

Referring to FIG. 18, the position of the hole and the size of the pipe connected to the first humidifying water tank 300 will be described. A pipe diameter 390d of the first connection pipe 390 may be larger than a pipe diameter 392d of the second connection pipe 392. A pipe diameter 394d of the drain pipe 394 may be larger than the pipe diameter 390d of the first connection pipe 390. A pipe diameter 310d of the communication pipe 310 may be larger than the pipe diameter 390d of the first connection pipe 390.

The first connection pipe 390 may be connected to the first humidifying water tank 300 above the second connection pipe 392. The drain pipe 394 may be connected to the first humidifying water tank 300 below the first connection pipe 390. The communication pipe 310 may be connected to the first humidifying water tank 300 above the first connection pipe 390.

The first temperature sensor 336 may be disposed between a position at which the first connection pipe 390 is connected to the first humidifying water tank 300 and a position at which the second connection pipe 392 is connected to the first humidifying water tank 300.

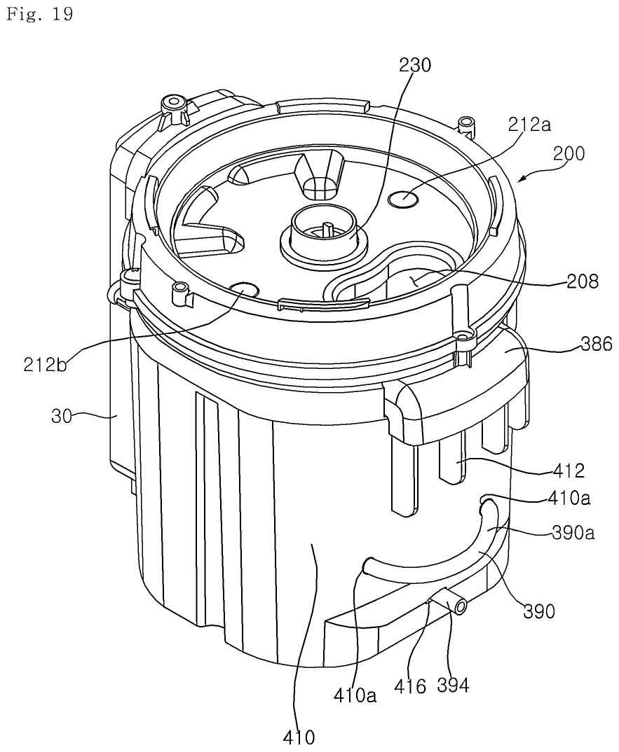

Hereinafter, structure and an arrangement of the first connection pipe 390 according to another embodiment will be described with reference to FIGS. 19 to 23. This description will focus on differences from the arrangement of the previous embodiment. Structure not described below may be considered as the same structure as the structure described in FIGS. 1 to 18.

Referring to FIG. 19, a portion of first connection pipe 390 is exposed to the outside of the humidifying module housing 410. The first connection pipe 390 may include an exposed pipe 390a exposed to the outside of the humidifying module housing 410.

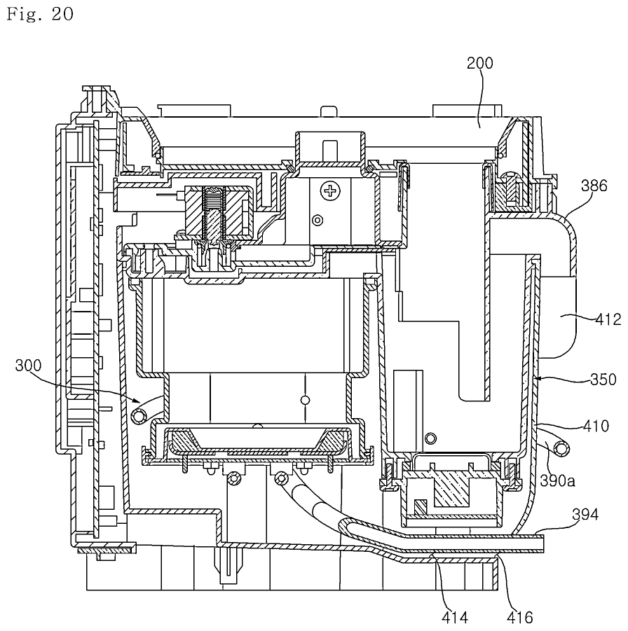

Referring to FIGS. 19 to 20, the exposed pipe 390a may be disposed at the lower side of the air guide cover 386. The exposed pipe 390a may be disposed in contact with the air flowing into the air guide cover 386.

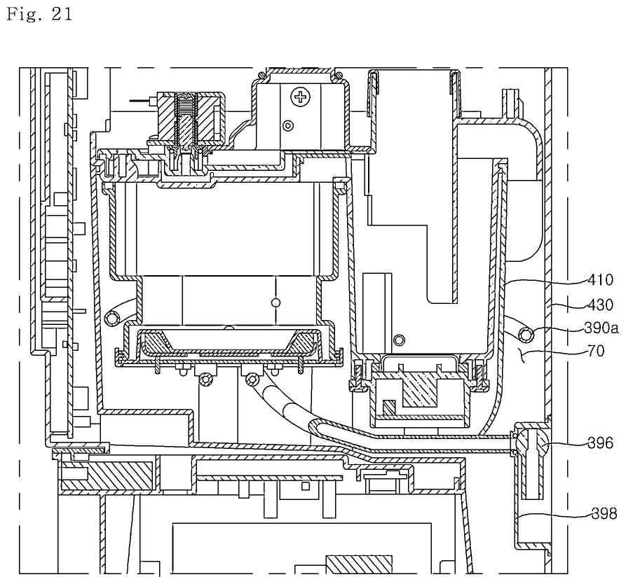

Referring to FIG. 21, the exposed pipe 390a may be disposed in the blower flow path 70. Therefore, when the fan 62 operates, a flow of air may flow around the exposed pipe 390a. The water that flows through the first connection pipe 390 and is supplied to the second humidifying water tank 350 may be cooled in the exposed pipe 390a.

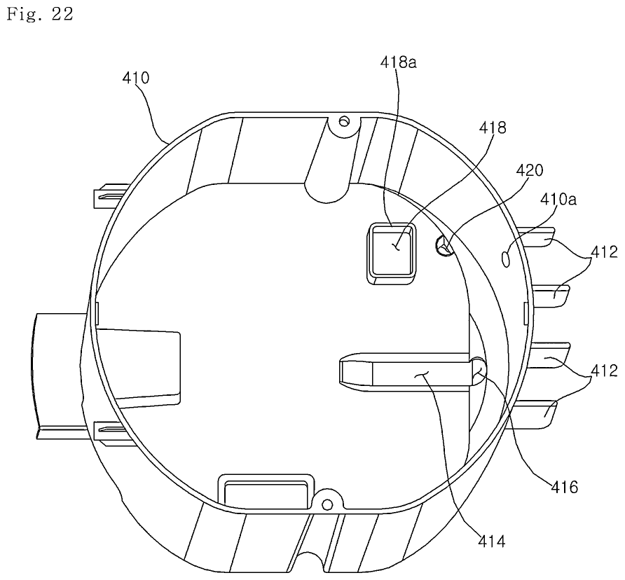

Referring to FIG. 22, a connection pipe hole 410a through which the first connection pipe 390 penetrates may be formed in or at one side of the humidifying module housing 410. The connection pipe hole 410a may fix the arrangement of the first connection pipe 390.

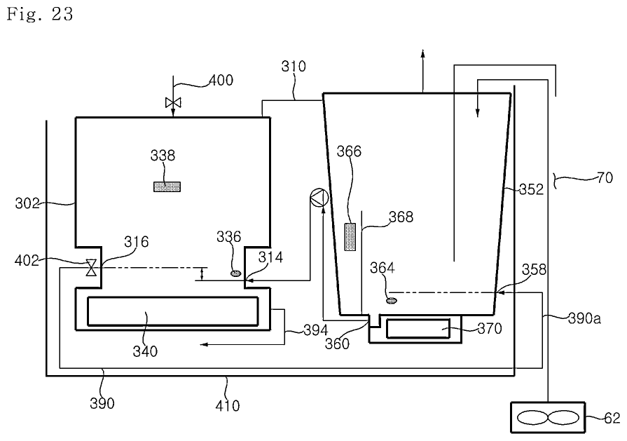

Referring to FIG. 23, a portion of the first connection pipe 390 that connects the first humidifying water tank 300 and the second humidifying water tank 350 may be disposed outside of the humidifying module housing 410. A portion of the first connection pipe 390 disposed outside of the humidifying module housing 410 may be disposed on the blower flow path 70 so that the heated water flowing into the second humidifying water tank 350 may be cooled.

According to a humidifier according to embodiments disclosed herein, one or more of the following advantages are achieved.

When the temperature of the water heated in the first humidifying water tank is a set or predetermined temperature or higher, water is supplied to the second humidifying water tank through a valve to humidify a completely sterilized water, thereby providing a user with clean humidified air. Further, when the temperature of the water in the second humidifying water tank is a certain or predetermined temperature or lower, the vibrator operates and stability of the vibrator may be ensured. This has an advantage of improving reliability of the vibrator.

Furthermore, the connection pipe and the fan are operated to cool the water supplied to the humidifier, thereby stably operating the vibrator. In addition, through the water softener, pure water from which ions are removed is heated, and through the first humidifying water tank in which the heater is disposed, the water sterilized by heating is humidified, and clean humidified air is provided to a user, thereby improving comfort in user's environment.

The water level and temperature inside of the first humidifying water tank and the second humidifying water tank are sensed, and based on such information, the heater, the vibrator, the valve, and the fan are operated, thereby stably operating the humidifier.

Embodiments disclosed herein has been developed in view of the above problems, and may provide a humidifier that humidifies water completely sterilized through heating.

Embodiments disclosed herein provide a humidifier in which a vibrator inside of a humidifying water tank supplied with high-temperature heated water may operate stably. Embodiments disclosed herein further provide a humidifier that may cool high-temperature heated water flowing into a humidifying water tank. Embodiments disclosed herein furthermore provide a humidifier that discharges humidified air using water from which ions in water are removed and pure clean water sterilized by heating.

Embodiments disclosed herein provide a humidifier that may stably maintain a water level inside of a first humidifying water tank that heats water and a second humidifying water tank that humidifies water. In addition, embodiments disclosed herein provide a humidifier that may stably operate through information on the temperature or water level of water in a first humidifying water tank and water in a second humidifying water tank.

Embodiments disclosed herein provide a humidifier that may include a tank that stores water; a first humidifying water tank that is disposed in or at a lower side of the water tank and heats water supplied from the water tank using a heater; a second humidifying water tank that is disposed in or at the lower side of the water tank and generates humidified air using water supplied from the first humidifying water tank via a vibrator; a first connection pipe that connects the first humidifying water tank and the second humidifying water tank; a first valve that opens and closes a flow path connecting the water tank and the first humidifying water tank; a second valve that opens and closes the first connection pipe; and a first temperature sensor that detects a temperature of water inside of the first humidifying water tank. The second valve may open the first connection pipe, when the temperature of water detected by the first temperature sensor is equal to or higher than a first set or predetermined temperature, so that humidified air may be generated using completely sterilized water.

When the second valve opens the first connection pipe, water in the first humidifying water tank may flow into the second humidifying water tank due to a difference between a water level of the first humidifying water tank and a water level of the second humidifying water tank, so that water heated in the second humidifying water tank may be supplied to the humidifier without the need for a separate pump. The first valve may be disposed closer to the first humidifying water tank than the second humidifying water tank, so that a flow path through which heated water flows into the second humidifying water tank can be secured. The water flowing into the second humidifying water tank may be partially cooled.

The humidifier may further include a second temperature sensor that detects a temperature of water stored inside of the second humidifying water tank. The vibrator may operate, when the temperature of water in the second humidifying water tank detected by the second temperature sensor is below a set or predetermined temperature, thereby preventing the vibrator from operating at high temperatures.

The humidifier may further include a first water level sensor that detects a water level inside of the first humidifying water tank. The first valve may stop water supplied to the first humidifying water tank, when the water level detected by the first water level sensor is equal to or higher than a first set water level.

A fan, which supplies air to the second humidifying water tank, may operate, when the heater heats water stored in the first humidifying water tank.

In the first humidifying water tank, an outlet hole may be formed in a portion connected to the first connection pipe, and the first temperature sensor may be disposed in a position equal to or lower than the outlet hole. Even when the water in the first humidifying water tank flows as much as possible into the second humidifying water tank, the temperature sensor may detect the water temperature in the first humidifying water tank.

The humidifier may further include a second water level sensor that detects a water level inside of the second humidifying water tank. The second valve may open the first connection pipe, when a level difference between water stored inside of each of the first humidifying water tank and the second humidifying water tank detected by the first water level sensor and the second water level sensor is formed. Operation of the vibrator may be stopped, when water level stored in the second humidifying water tank detected by the second water level sensor is lower than a set or predetermined water level, thereby preventing the vibrator from being damaged by operating the vibrator when a certain water level is not formed.

The second humidifying water tank may include a water level sensor cover disposed between the second water level sensor and the vibrator, thereby improving the accuracy of the second water level sensor. The second valve may open the first connection pipe for a set or predetermined time, so that the water supplied to the second humidifying water tank may be adjusted.

The humidifier may further include a second temperature sensor that detects a temperature of water stored inside of the second humidifying water tank. The vibrator may operate, when the temperature of water inside the second humidifying water tank detected by the second temperature sensor is below a set or predetermined temperature, thereby preventing the vibrator from operating at high temperatures.

In the second humidifying water tank, an inlet hole may be formed in a portion connected to the first connection pipe. The second temperature sensor may be disposed at a same height as the inlet hole or at a lower height than the inlet hole, so that the temperature of the water flowing from the first humidifying water tank may be quickly detected.

The humidifier may further include a second connection pipe that is spaced apart from the first connection pipe and connects the first humidifying water tank and the second humidifying water tank, and a pump that pumps water stored inside of the second humidifying water tank to the first humidifying water tank through the second connection pipe. The pump may operate after the vibrator stops operating, so that when the generation of humidified air is completed, water may be returned to the first humidifying water tank. The pump may operate in consideration of a water level inside of the first humidifying water tank detected by the first water level sensor and a water level inside of the second humidifying water tank detected by the second water level sensor, thereby preventing water from being recovered beyond a range in which the first humidifying water tank may store.

The humidifier may further include a water softener that is disposed inside of the water tank and removes ion from water discharged from the water tank; a supply pipe that connects the water tank and the first humidifying water tank; and a detection sensor that detects a quality of water stored inside of the supply pipe. The first valve may be disposed in one end of the supply pipe and control water supplied to the first humidifying water tank, so that humidified air may be generated by heating water from which ions are removed.

The first valve may supply water to the first humidifying water tank, when the quality of water detected by the detection sensor is equal to or higher than a set or predetermined level, so that humidified air may be generated by heating water from which ions are removed.

Embodiments disclosed herein provide a humidifier that may include a first humidifying water tank in which a first chamber to heat water stored therein is formed; a second humidifying water tank in which a second chamber that generates humidified air using water stored therein is formed; and a connection pipe that supplies the water heated in the first humidifying water tank to the second humidifying water tank. The second humidifying water tank may include a second humidifying water tank wall that forms the second chamber; a vibrator that is disposed at a lower side of the second humidifying water tank wall and atomizes water stored in the second chamber; and a temperature sensor that detects a temperature of the water stored in the second chamber. The vibrator may operate, when the temperature detected by the temperature sensor is below a set or predetermined temperature, thereby preventing the vibrator from operating in the presence of high temperature heated water.

The second humidifying water tank may further include a water level sensor that detects a water level inside of the second humidifying water tank. The vibrator may operate when the water level in the second humidifying water tank is equal to or higher than a set or predetermined water level, thereby preventing the vibrator from operating in a state in which the water level is not secured, as the vibrator operates.

Embodiments disclosed herein provide a humidifier that may include a first humidifying water tank in which a first chamber to heat water stored therein is formed; a second humidifying water tank in which a second chamber that generates humidified air using water stored therein is formed; a connection pipe that supplies the water heated in the first humidifying water tank to the second humidifying water tank; and a valve that opens and closes the connection pipe. The first humidifying water tank may include a first humidifying water tank wall that forms the first chamber, and a heater that is disposed at a lower side of the first humidifying water tank wall and heats water stored in the first chamber. The heater may operate when the valve closes the connection pipe, so that completely heated and sterilized water may be supplied to the second humidifying water tank.

Although embodiments has been described with reference to specific embodiments shown in the drawings, it is apparent to those skilled in the art that the embodiments are not limited to those exemplary embodiments and is embodied in many forms without departing from the scope, which is described in the following claims. These modifications should not be individually understood from the technical spirit or scope.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A humidifier, comprising:
a tank that stores water;
a first humidifying water tank that is disposed at a lower side of the water tank and heats water supplied from the water tank using a heater;
a second humidifying water tank that is disposed at the lower side of the water tank and generates humidified air using water supplied from the first humidifying water tank via a vibrator;
a first connection pipe that connects the first humidifying water tank and the second humidifying water tank;
a first valve that opens and closes a flow path connecting the water tank and the first humidifying water tank;
a second valve that opens and closes the first connection pipe; and
a first temperature sensor that detects a temperature of water inside of the first humidifying water tank, wherein the second valve opens the first connection pipe, when the temperature of water detected by the first temperature sensor is equal to or higher than a first predetermined temperature.

2. The humidifier of claim 1, wherein the first valve is disposed closer to the first humidifying water tank than the second humidifying water tank.

3. The humidifier of claim 1, further comprising a second temperature sensor that detects a temperature of water stored inside of the second humidifying water tank, wherein the vibrator operates, when the temperature of water in the second humidifying water tank detected by the second temperature sensor is below a predetermined temperature.

4. The humidifier of claim 1, wherein when the second valve opens the first connection pipe, water in the first humidifying water tank flows into the second humidifying water tank due to a difference between a water level of the first humidifying water tank and a water level of the second humidifying water tank.

5. The humidifier of claim 4, further comprising:
a second connection pipe that is spaced apart from the first connection pipe and connects the first humidifying water tank and the second humidifying water tank; and
a pump that pumps water stored inside of the second humidifying water tank to the first humidifying water tank through the second connection pipe, wherein the pump operates after the vibrator stops operating.

6. The humidifier of claim 5, wherein the pump operates based on a water level inside of the first humidifying water tank detected by the first water level sensor and a water level inside of the second humidifying water tank detected by the second water level sensor.

7. The humidifier of claim 1, further comprising a first water level sensor that detects a water level inside of the first humidifying water tank, wherein the first valve stops supply of water to the first humidifying water tank, when the water level detected by the first water level sensor is equal to or higher than a first predetermined water level.

8. The humidifier of claim 7, further comprising a second water level sensor that detects a water level inside of the second humidifying water tank, wherein the second valve opens the first connection pipe, when a level difference between the water stored inside each of the first humidifying water tank and the second humidifying water tank detected by the first water level sensor and the second water level sensor is formed.

9. The humidifier of claim 8, wherein operation of the vibrator is stopped, when the water level in the second humidifying water tank detected by the second water level sensor is lower than a predetermined water level.

10. The humidifier of claim 8, wherein the second humidifying water tank comprises a water level sensor cover disposed between the second water level sensor and the vibrator.

11. The humidifier of claim 1, wherein a fan, which supplies air to the second humidifying water tank, operates, when the heater heats water stored in the first humidifying water tank.

12. The humidifier of claim 1, wherein an outlet hole is formed in the first humidifying water tank in a portion connected to the first connection pipe, and wherein the first temperature sensor is disposed at a position equal to or lower than the outlet hole.

13. The humidifier of claim 1, wherein the second valve opens the first connection pipe for a predetermined period of time.

14. The humidifier of claim 1, further comprising a second temperature sensor that detects a temperature of water stored inside of the second humidifying water tank, wherein the vibrator operates, when the temperature of water inside of the second humidifying water tank detected by the second temperature sensor is below a predetermined temperature.

15. The humidifier of claim 14, wherein an inlet hole is formed in the second humidifying water tank in a portion connected to the first connection pipe, wherein the second temperature sensor is disposed at a same height as the inlet hole or at a lower height than the inlet hole.

16. The humidifier of claim 1, further comprising:
a water softener that is disposed inside of the water tank and removes ion from water discharged from the water tank;
a supply pipe that connects the water tank and the first humidifying water tank; and
a detection sensor that detects a quality of water stored inside of the supply pipe, wherein the first valve is disposed at one end of the supply pipe and controls the water supplied to the first humidifying water tank.

17. The humidifier of claim 16, wherein the first valve supplies water to the first humidifying water tank, when the quality of water detected by the detection sensor is equal to or higher than a predetermined level.

18. A humidifier, comprising:
a first humidifying water tank in which a first chamber that heats water stored therein is formed;
a second humidifying water tank in which a second chamber that generates humidified air using water stored therein is formed; and
a connection pipe that supplies the water heated in the first humidifying water tank to the second humidifying water tank, wherein the second humidifying water tank comprises:
a second humidifying water tank wall that forms the second chamber;
a vibrator that is disposed at a lower side of the second humidifying water tank wall and atomizes water stored in the second chamber; and
a temperature sensor that detects a temperature of the water stored in the second chamber, wherein the vibrator operates, when the temperature detected by the temperature sensor is below a predetermined temperature.

19. The humidifier of claim 18, wherein the second humidifying water tank further comprises a water level sensor that detects a water level inside of the second humidifying water tank, and wherein the vibrator operates when the water level in the second humidifying water tank is equal to or higher than a predetermined water level.

20. A humidifier, comprising:
a first humidifying water tank in which a first chamber that heats water stored therein is formed;
a second humidifying water tank in which a second chamber that generates humidified air using water stored therein is formed;
a connection pipe that supplies the water heated in the first humidifying water tank to the second humidifying water tank; and
a valve that opens and closes the connection pipe, wherein the first humidifying water tank comprises:
a first humidifying water tank wall that forms the first chamber; and
a heater that is disposed at a lower side of the first humidifying water tank wall and heats water stored in the first chamber, wherein the heater operates when the valve closes the connection pipe.
